(19) United States
(12) Patent Application Publication
(10) Pub. No.: US 2008/0208480 A1
(43) Pub. Date: Aug. 28, 2008

(54) INFORMATION MANAGEMENT SYSTEM AND INFORMATION MANAGEMENT SERVER

(76) Inventors: Hiroyuki KURIYAMA, Kawasaki (JP); Kazuo Yano, Hino (JP); Shunzo Yamashita, Musashino (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/962,316

(22) Filed: Dec. 21, 2007

(30) Foreign Application Priority Data
Feb. 23, 2007 (JP) 2007-044161

(51) Int. Cl. G01D 21/00; G06F 17/18; G06F 19/00

(52) U.S. Cl. 702/19; 702/179

(57) ABSTRACT

For the purpose of effectively supervising a user of the health indexes that cannot always be measured, such as the weight and blood pressure, warning and information are provided based on a prediction of the health indexes. In an information management system, in which a first parameter that is not always measured is predicted from a second always measurable parameter.

### CLAIM OF PRIORITY

The present application claims priority from Japanese application JP 2007-044161 filed on Feb. 23, 2007, the content of which is hereby incorporated by reference into this application.

### FIELD OF THE INVENTION

The present invention relates to information management systems which predict a parameter which cannot be measured discretely from an always measurable parameter. More particularly, the invention relates to an information management system that predicts arbitrary indexes of, such as physical conditions, mental conditions, productivity, and safety, which cannot always be measured based on always measurable living body information, and generates warning if needed.

### BACKGROUND OF THE INVENTION

In recent years, a network system which takes various information on the real world into an information processor in real time is investigated (hereinafter a sensor network) by adding a small electronic circuit having a wireless communication function to a sensor. A wide range of applications have been studied for the sensor network, for example, a proposal is made for medical service application such that by a small electronic circuit with a wireless circuit, a processor, a sensor, and a battery are integrated thereon, living body information such as a pulse is always monitored, and monitored results are transmitted to a diagnosis apparatus through wireless communications, and a user's health condition is determined based on the monitored results.

Various technique is proposed as an art to monitor a living body condition, and in one of them a user's (wearing person) living activities are supervised by a sensor, and if the activities deviate from the normal life pattern set up beforehand, warning is generated to the user, as disclosed in e.g. JP-A No. 2004-133777.

In order to conjecture a user's present concerns on networks, such as an internet, the art of correcting the profile which shows the present user's concerns is also known as disclosed, for example, in JP-T No. 2004-514217.

In a traffic application klaxon horn and braking information caused by unspecified drivers are put on map information, and although an accident has not yet occurred, a dangerous location is predicted, or a stress placed on a driver is detected and displayed on the map of the position the driver felt the stress thereon, as disclosed in e.g. JP-A No. 2005-038381.

In another medical service application data of living activities, such as the number of walking steps and smoking is inputted together with health information, such as blood pressure, a rule to predict the relationship between the living activities and the health condition is automatically generated by data mining, and the prediction or warning of health condition is made based on the input data, as disclosed in e.g. JP-A No. 2005-045696.

### SUMMARY OF THE INVENTION

The health indexes showing the condition of living bodies, such as weight and blood pressure, are measured by dedicated measuring instruments and these cannot be measured constantly, but only measured periodically (or intermittent or discrete), therefore, the health condition had to be considered from the transition of health indexes. As for clinical examinations such as a blood test, the measurement is made only a few times a year at health examinations, and the clinical examinations data is not suited as health indexes to represent daily health conditions since the measurement interval is too large.

Although the health index indicating subjective states such as attentiveness and stress is not yet fully established, the indexes reflecting a worker's mental health condition can be found out: for example, the number of processed affaires for business work, or the number of operation errors for machine operation, etc. from a viewpoint of productivity or safety. However, it is difficult to measure these indexes always during work, although the mental condition can be known after the work by totaling these indexes at the end of the day.

There is a demand for always grasping such indexes of health and safety. The index of health can always be provided with respect to the measurable state by the sensor of the related art disclosed in the above-mentioned patent documents; however, no indexes could be provided with respect to a weight, a blood pressure, a blood sugar level, and stress that cannot always be measured.

The technique disclosed in JP-A No. 2005-045696 has a difficulty that the index of health or safety is given only as a discrete value because the applied technique is such that a prediction rule is first formulated and the measured index is checked to be adapted or not to the rule, therefore, the index cannot be monitored in real time.

An object of the present invention is therefore to monitor the index that cannot always be measured based on always measurable information by a sensor and furthermore to notify information or to perform warning based on the predicted index.

In an information management system that predicts a first parameter that cannot always be measured from a second parameter that can always be measured, the system includes a first measurement section that measures the first parameter discretely, and a second measurement section that measures the second parameter always, a data storage section which stores the values of the first measured parameter and the second parameter, a prediction formula generator section which generates a prediction formula for calculating a predicted value of the first parameter from the first and the second parameters stored in the data storage section, and a predicted value calculating section for calculating a predicted value of the first parameter based on the generated prediction formula and the second measured parameter, in which the prediction formula generator section generates a prediction formula every time at predetermined timing.

The prediction formula generator section generates a prediction formula by a multiple regression analysis in which the first measured parameter measured discretely is as a response variable, and the second measured parameter measured always as a predictor variable, and includes a scalar calculating section to calculate the scalar part of acceleration of the second measured parameter, a zero cross count calculating section to count number of times the scalar part crosses zero point or a predetermined neighborhood, and a frequency calculating section to count frequency of zero cross occurrence within a predetermined time interval, in which the frequency of zero cross occurrence is specified as a predictor variable.

The present invention is therefore applied to always record the second parameter acquired from the second measurement section although the first parameter cannot always be measured, and based on the recorded data, generate a prediction formula for the first parameter with a high correlation; thereby, conjecture a situation in real time with respect to the first parameter unable to always be measured such as weight or stress and perform prediction and warning if necessary.

Especially, prediction of the trend over the first parameter a user wants to know becomes possible by only always recording the information of the user's body and behavior with an acceleration sensor of the second measurement section worn on the user's body.

### BRIEF DESCRIPTION OF THE DRAWINGS

FIG. 1 is a block diagram to show an information management system according to an embodiment of the present invention;

FIG. 2 is a perspective view of the surface of a bracelet type sensor node;

FIG. 3 is a perspective view of the back of the bracelet type sensor node;

FIG. 4 is a block diagram to show a composition of the sensor node according to an embodiment of the present invention.

FIG. 5 is a flow chart to show an example of the measuring process of the pulse performed by the sensor node according to an embodiment of the present invention;

FIG. 6 is a flow chart to show an example of the measuring process of the acceleration by the sensor node according to an embodiment of the present invention;

FIG. 7 is a graph to show a schematic variation of the magnitude of acceleration with time illustrating the number of times of the zero crossing with a threshold of 0.05 G;

FIG. 8 is a flow chart to show an example of the measuring process of the weight by the sensor node according to an embodiment of the present invention;

FIG. 9 is an explanatory view showing an example of the message at the time of weight measurement shown on the display section of the sensor node;

FIG. 10 is a flow chart to show an example of transmitting process of the sensing data performed by the sensor node according to an embodiment of the present invention;

FIG. 11 is an explanatory view to show a transmission frame from the sensor node according to an embodiment of the present invention;

FIG. 12 is an explanatory view to show an example of the weight table of the data server according to an embodiment of the present invention;

FIG. 13 is an explanatory view to show an example of the data table of the data server according to an embodiment of the present invention;

FIG. 14 is a block diagram to show a composition of the scale according to an embodiment of the present invention;

FIG. 15 is a block diagram to show a data processing flow of information management system according to an embodiment of the present invention;

FIG. 16 is a graph to show a schematic variation of the zero crossing frequency with time;

FIG. 17 is a graph with a table to show a schematic variation of the zero crossing frequency with time, appearance frequency distribution, and appearance ratio distribution table;

FIG. 18 is a graph with a table to show a schematic variation of the zero crossing frequency with time, appearance frequency distribution, and continuation index distribution table;

FIG. 19 is an explanatory view to show an example of the multiple regression analysis table of the analyzer apparatus according to an embodiment of the present invention.

FIG. 20 is a graph to show a schematic variation of the weight with time for a predicted curve and measured values;

FIG. 21 is an explanatory view to show an example of message on display when a predicted changing weight rate exceeds a predetermined value;

FIG. 22 is a flow chart to show an example of a predictor variable generating section, generation of an predictor variable performed in the multiple regression analysis processing section of the analyzer apparatus, and a generation processing of a prediction formula.

FIG. 23 is a flow chart to show an example of a prediction processing performed by the prediction data generating section of the analyzer apparatus;

FIG. 24 is a block diagram to show an information management system according to a second embodiment of the present invention.

FIG. 25 is an explanatory view to show a transmission frame from the sensor node according to an embodiment of the present invention.

FIG. 26 is an explanatory view to show a waveform table of the data server according to an embodiment of the present invention;

FIG. 27 is a flow chart to show an example of generation processing of a predictor variable performed in the multiple regression analysis processing section of the analyzer apparatus according to a third embodiment of the present invention.

FIG. 28 is an explanatory view to show an example of the multiple regression analysis table of the analyzer apparatus according to an embodiment of the present invention;

FIG. 29 is a flow chart to show an example of the measuring process of the acceleration by the sensor node according to a fourth embodiment of the present invention;

FIG. 30 is an explanatory view to show an example of an input screen of the stress index outputted to the display section of the analyzer apparatus according to a fifth embodiment of the present invention; and

FIG. 31 is an explanatory view to show another example of an input screen of the stress index outputted to the display section of the analyzer apparatus according to the fifth embodiment of the present invention.

### DETAILED DESCRIPTION OF THE PREFERRED EMBODIMENTS

Preferred embodiments of the present invention are described below based on the accompanying drawings.

### First Embodiment

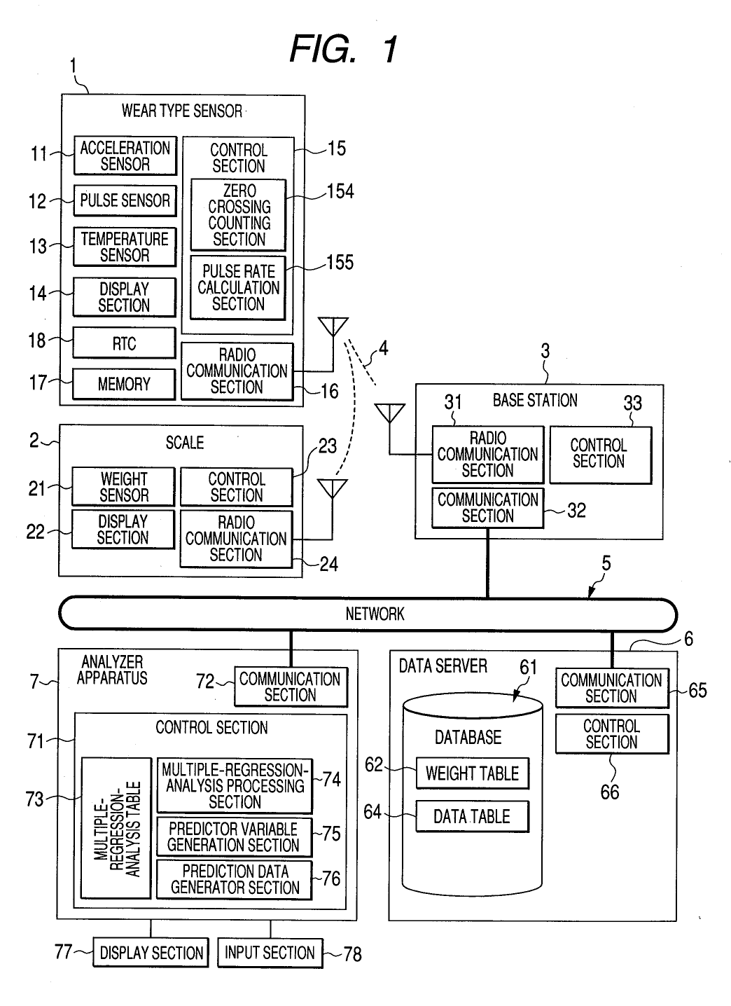

FIG. 1 is a block diagram of an information management system for managing a user's health condition using a sensor networks system (hereinafter referred to a “sensor net”) according to a first embodiment of the invention. In the information management system of the embodiment, a user's weight is predicted as a health index unable to be measured always based on always measured living body information from the sensor worn on the user's body, and a warning is given under predetermined conditions.

A wear type sensor 1 (hereinafter, referred to a sensor node) is worn to a human body (for example, arm etc.) and always measures information on the living body (a pulse, acceleration of movement), then transmits the information to a base station 3, or receives information from the base station 3, which is transmitted to a wearing person. The sensor node 1 and base station 3 are connected through a wireless network 4, such as IEEE802.15.4 (ZigBee). The wearing person of sensor node 1 is a user of the health information management system of the invention in the following explanation. The sensor node 1 functions as a measurement section (the second measurement section) which always measures measurable parameters.

A weighing device or scale 2 is also connected to a wireless network 4, and the scale 2 transmits the weight measured discretely to the sensor node 1. The sensor node 1 adds an identifier (ID) of the sensor node 1 to the information (body weight) received from the scale 2, and transmits the information to a data server 6 via the base station 3. A plurality of sensor nodes 1 and scales 2 may exist, and also a plurality of base stations 3 may be arranged. The scale 2 functions as a measurement section (the first measurement section) which measures discretely the parameters unable to be always measured.

The base station 3 transmits the living body information (hereinafter, referred to a sensing data) received from the sensor node 1 to the data server 6 via a network 5, and the data server 6 stores the sensing data always measured by the sensor node 1, and the weight data discretely measured by the scale 2 in a database 61.

The sensing data including the acceleration of the sensor nodes 1 and the intermittent or discrete weight data measured by the scale 2 accumulated in data server 6, are analyzed, to be described later by an analyzer 7 connected to the network 5, so that a health index such as a user's weight unable to be measured always is estimated from the always measured sensing data of sensor node 1 in real time, and prediction and warning are performed if needed.

That is, in the sensor network of the present invention, a user measures user's weight with the scale 2 every day or at an arbitrary interval discretely, and from the discretely measured history of the weight and real time information of behavior monitored always with an acceleration sensor 11 of the sensor nodes 1 the weight is estimated in real time as described later.

The sensor node 1 includes the acceleration sensor 11 which always measures a wearing person's movement, a pulse sensor 12 which always measures a wearing person's pulse, and a temperature sensor 13 which always measures a wearing person's body temperature or an environmental temperature, in which the number of times of the zero crossing is obtained from the measured acceleration to be described later. The sensor node 1 includes a control section 15 configured from a microcomputer etc. for controlling the acceleration sensor 11, the pulse sensor 12, and the temperature sensor 13, the control section 15 calculates the number of times of the zero crossing from the detected acceleration, and transmits the sensing data containing the number of times of the zero crossing, a pulse, and a temperature from a radio communication section 16 to the base station 3. An example of the acceleration sensor 11 is able to measure the acceleration along three axes of X (before or after), Y (right and left), and Z (upper and lower sides), respectively, and always to monitor the motion of a human body (living body).

The control section 15 controls a display section 14 for indicating measured information including the pulse etc., a memory 17 for storing data, and a real time clock (RTC) 18 for setting the measurement cycle of each sensor, etc. The control section 15 calculates a scalar component of detected acceleration, and includes a zero crossing calculation section 154 for calculating the number of times the scalar quantity of acceleration becomes zero G or a predetermined threshold (for example, 0.05 G) as the number of times of the zero crossing. The control section 15 transmits the number of times of the zero crossing as living body information on the wearing person's behavior. Specifically, the control section 15 once stores the number of times of the zero crossing obtained from the measured acceleration in the memory 17, and transmits it collectively at predetermined every transmission period (for example, 1 minute). Accordingly, the number of times of the zero crossing transmitted is the number of times of the zero crossing per predetermined transmission period. The control section 15 may count the number of steps of a wearing person based on the scalar quantity of acceleration if the person is in a walking state.

The control section 15 includes a pulse rate calculation section 155 for calculating a pulse rate from the pulse measured with the pulse sensor 12, and transmits the pulse rate as living body information to shows a wearing person's body information. In the case that the power consumption is restrained by performing the communication with the base station 3 intermittently, the living body information such as the number of times of the zero crossing or the pulse rate, etc., obtained by the sensor node 1 may be transmitted collectively at the time of communication with the base station 3.

The living body information always measured by the sensor node 1 includes the body information to show the health condition of a sensor node 1 wearing person, such as a pulse and body temperature, and the behavior information to show the action or movement of the wearing person, such as the number of times of the zero crossing based on the acceleration of movement. Although the body information measured by the sensor node 1 are a pulse and temperature in the embodiment of the present invention, any other measurable information may also be used and not limited to the above indexes.

Next, the scale 2 is composed from a weight sensor 21 for measuring the weight of a human body discretely, a display section 22 for indicating the measured weight, a radio communications section 24 for transmitting the measured weight, and a control section 23 for controlling the weight sensors 21, a display section 22, and a radio communication section 24.

The base station 3 includes a radio communication section 31 for transmitting to and receiving from the sensor node 1, a communication section 32 for transmitting to and receiving from the network 5, and a control section 33 for controlling these communication sections. The control section 33 is composed from a CPU, a memory, and a storage device, etc.

A data server 6 is a computer including a database 61 for storing the sensing data from the sensor node 1 and the discrete weight data measured with the scale 2, a communication section 65 for transmitting to and receiving from the network 5, and a control section 66 for controlling the database 61 and the communication section 65. The control section 66 includes a CPU and a memory, and executes a software (DBMS) which manages the database 61. The database 61 is stored in a storage device (not illustrated).

The database 61 contains a weight table 62 in which discretely measured weight data with the scale 2 are stored serially for every ID of the sensor node 1, and a data table 64 in which always measured behavior information such as the number of times of the zero crossing, and a pulse and body temperature are serially stored for every ID of the sensor node 1.

An analyzer apparatus 7 is a computer for analyzing the sensing data and weight data of the data server 6, and includes a control section 71 containing a CPU, a memory, and a storage device, and a communication section 72 for communicating with the network 5. The control section 71 generates a prediction formula by a multiple regression analysis from the number of times of the zero crossing for the acceleration stored in the data table 64 and the weight stored in the weight table 62 of the data server 6, and estimates a prediction data of weight.

For this reason, the control section 71 is provided with the following. The control section 71 includes a predictor variable generation section 75 for making the number of times of the zero crossing obtained from the data table 64 of the data server 6 as an predictor variable, and storing the predictor variable in a multiple regression analysis table 73, the multiple regression analysis table 73 for storing the discrete weight data of the data server 6 as a response variable and the number of times of the zero crossing of acceleration as a predictor variable, a multiple regression analysis processing section 74 for generates a prediction formula and performing a multiple regression analysis, and a prediction data generator section 76 for calculating a predicted value of weight based on the generated prediction formula. The analyzer apparatus 7 includes a display section 77 for indicating a predicted and measured values of weight, and the number of times of the zero crossing, etc., and an input section 78 containing a keyboard, a mouse, etc.

### <Details of a Sensor Node>

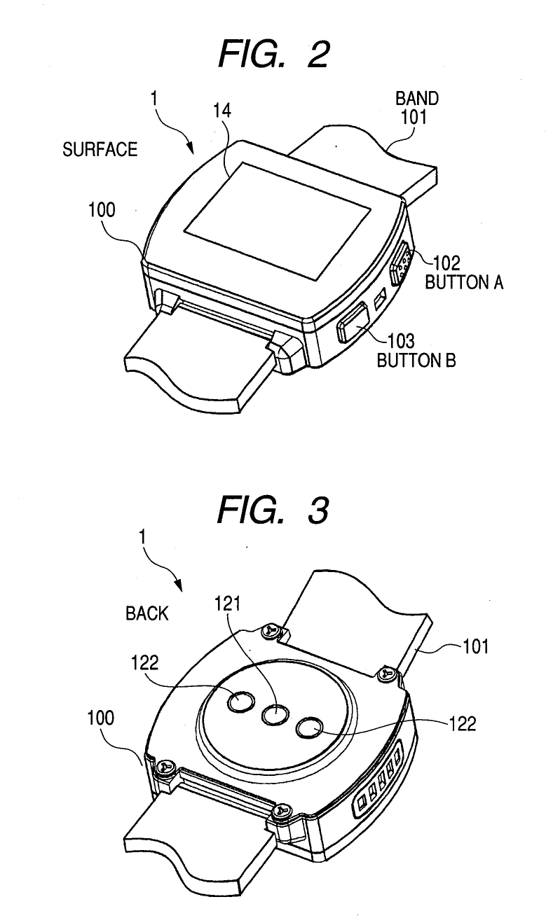

FIGS. 2 and 3 are perspective views of a sensor node 1 of an arm ring type to be worn to an arm of a user, and FIG. 2 shows the surface and FIG. 3 shows the back of the sensor node.

The sensor node 1 includes a case 100 for storing each sensor and a controller, and a band 101 the case 100 is worn to a user's arm therewith as shown in FIG. 2.

The case 100 stores the control section 15 and each sensors 11-13. The display section 14 is arranged on the surface of case 100 for indicating a message etc. A liquid crystal display etc. may be employed as the display section 14.

Buttons A102 and B103 operable by a wearing person are arranged on the side of case 100. For example, an emergency is notified outside by operating the button A102 by a wearing person, and a reply is sent by operating the button B103 for responding to a request about a body information measurement (a pulse or weight, etc.), or an inquiry from the display section 14 (message), etc.

The pulse sensor 12 including a light emitting element 122 and a light receiving element 121 is arranged on the back surface of case 100 of the sensor node 1 as shown in FIG. 3. An infrared-emitting diode is used as the light emitting element 122, and a photo transistor is adopted as the light receiving element 121 in the pulse wave sensor 12. A photodiode may be also used as a light emitting element besides a photo transistor. The light emitting element 122 and the light receiving element 121 are exposed to the back surface of the case 100, and both elements may face the skin of an arm.

The pulse sensor 12 irradiates a hypodermic blood vessel with the infrared light generated by the light emitting element 122, and detects the intensity variation of scattered light from the blood vessel due to a blood-flow change with the light receiving element 121, and estimates a pulse and a pulse wave from the cycle of this intensity variation.

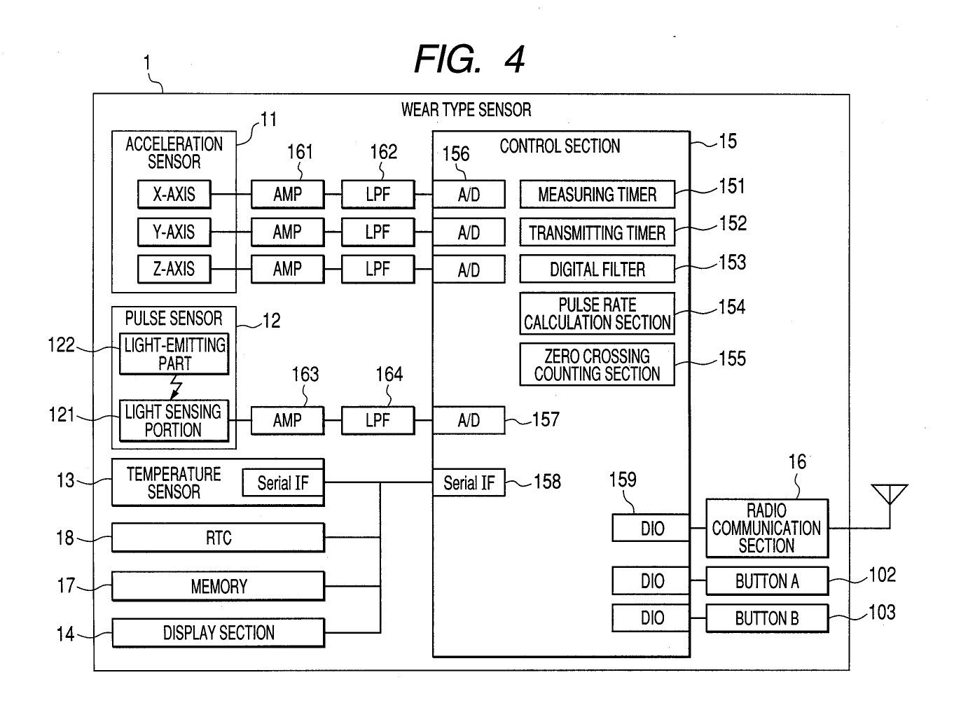

FIG. 4 shows a block diagram of the sensor node 1. The sensor node 1 includes the radio communication section 16 having an antenna for communicating with the base station 3, the control section 15 for controlling the acceleration sensor 11, the pulse sensor 12, the temperature sensor 13, and the display section 14, the real time clock 18 for functioning as a timer intermittently to start the control section 15 containing a microcomputer, and the memory 17 for storing data as shown in FIG. 4.

The acceleration sensor 11 comprises an X-axis sensor for detecting the acceleration along the X-axis (backward and forward direction of a human body), a Y-axis sensor for detecting the acceleration along the Y-axis (horizontal direction of a human body), and a Z-axis sensor for detecting the acceleration along the Z-axis (up-and-down direction of a human body). All outputs from the sensors are amplified with amplifiers 161, respectively, noises are removed therefrom with low pass filters 162, and then inputted into A/D converters 156 of the control section 15.

An output from the light receiving element 121 of the pulse sensor 12 is amplified with an amplifier 163, a noise is removed therefrom, and then inputted into an A/D converters 157 of the control section 15. The temperature sensor 13, the real time clock 18, the memory 17, and the display section 14 are connected to a serial I/F 158 of the control section 15, respectively, and transmission and reception of data or a command are performed. The control section 15 includes a measuring timer 151 for determining cycles therewith measurements of sensors 11-13 each are performed, a digital filter 153 for removing a noise component from the measured sensing data (acceleration, a pulse, temperature), a pulse rate calculation section 155 for calculating a pulse rate from the output of the pulse sensor 12, a zero cross counting section 154 for calculating the number of times of the zero crossing from the output of the acceleration sensor 11, and a transmitting timer 152 for determining the cycle at which the sensing data (the number of times of the zero crossing, a pulse rate, temperature) is transmitted based on measurement results. The measurement and transmission by the sensors 11 to 13 are performed in such a way that the measuring timer 151 and the transmitting timer 152 apply interruption at a predetermined frequency to each other CPU (microcomputer) of the control section 15, respectively, in the embodiment of the present invention.

For example, the measuring timer 151 applies interruption to the CPU of the control section 15 every 50 msec, and makes the CPU perform the measurements by the acceleration sensor 11, the pulse sensor 12, and the temperature sensor 13. And the transmitting timer 152 applies interruption to the CPU of the control section 15 every minute, and makes the CPU transmit output data from the zero cross counting section 154 and the pulse rate calculation section 155 and temperature to the base station 3.

The control section 15 is connected to the radio communication section 16, and the button A102 and the button B103 via digital I/Os 159.

As described above, the sensor node 1 acquires the output of each sensor every 50 msec, obtains the number of times of the zero crossing, a pulse rate, and temperature from the output of the sensors, and transmits the data thus obtained to the data server 6 from the base station 3 every minute. Consequently, the number of times of the zero crossing, a wearing person's behavior information, is stored in the data table 64 of the data server 6 as the number of times of the zero crossing per minute.

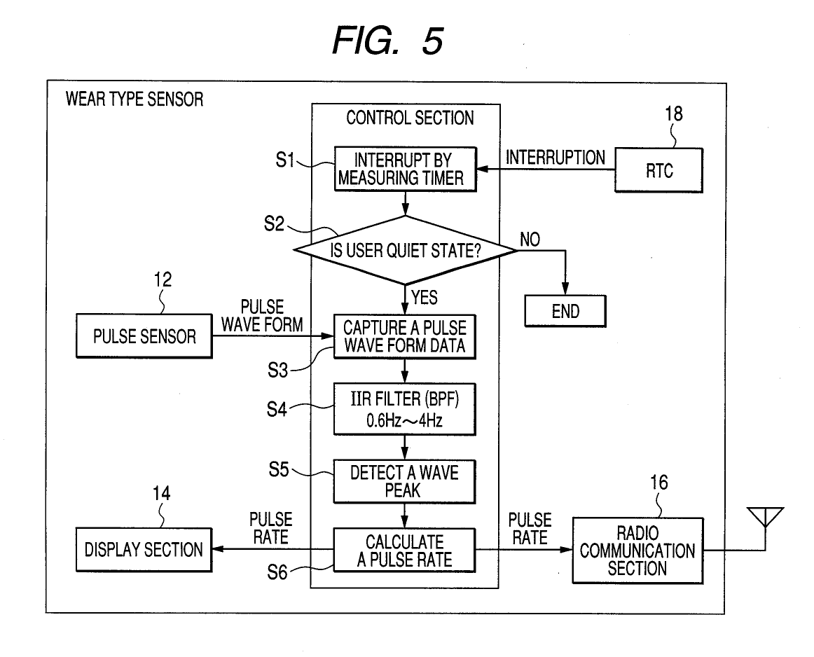

Next, FIG. 5 shows a flow chart of an example of a pulse measuring process when an interruption is applied to the microcomputer of the control section 15 by the measuring timer 151.

First in S1, the control section 15 activates the pulse sensor 12 and the acceleration sensor 11 when interrupted from the measuring timer 151. Next in S2, the control section 15 acquires the output of the acceleration sensor 11, and decides whether a wearing person is in a quiet state or not.

Although the pulse sensor 12 is worn to a user's arm, if the wearing person is moving, e.g. in running, only a disturbed wave is acquired since the light receiving element 121 attaches and detaches the skin, so that a normal pulse cannot be detected in this state. This is because the pulse sensor 12 is not stuck on the arm, and exposed to disturbance light with a time interval much shorter than a pulse cycle. Thus, in order to detect a reliable pulse, it is necessary to perform sensing, while a user is in a quiet state.

The control section 15 computes a magnitude of the detected acceleration, i.e., the absolute value of acceleration, compares this absolute value to a threshold value set previously, and if the absolute value is less than the threshold, and decides the user is in a quiescent state (=quiet state). More precisely, when the arm of the user wearing the sensor nodes 1 is in a quiescent state, the control section 15 judges the measurement start of the pulse is possible, and proceeds to S3.

On the other hand, when the wearing person is not in a quiescent state, the control section 15 ends the processing and wait for the person to be in a quiet state by next measurement timing.

In S3, the control section 15 acquires output from the pulse sensor 12, and captures the output as a pulse wave form data. In S4, the digital filter 153 extracts only a predetermined frequency band (for example, 0.6 Hz to 4 Hz). Next, in S5, a peak is extracted from the pulse wave form data after filtering process was applied (S5). And in S6, a pulse rate is obtained from the number of peaks per minute of the pulse wave form data, and outputted. The control section 15 can transmit the computed pulse rate to the base station 3 from radio communication section 16, or report the measurement result to a wearing person with the display section 14.

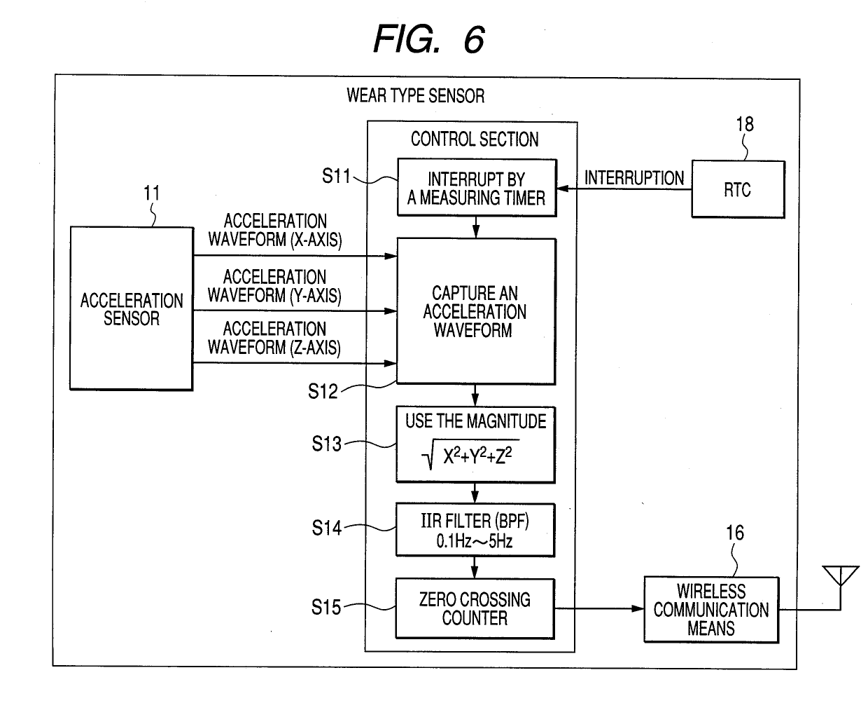

Next, FIG. 6 shows a flow chart of an example of a measuring process of the acceleration performed when an interruption is applied to the microcomputer of the control section 15 by the measuring timer 151.

First in S11, receiving an interruption from the measuring timer 151, the control section 15 activate the acceleration sensor 11. Next in S12, the control section 15 acquires the output (X, Y, Z) of the acceleration sensor 11 for each axis, and obtains the wave form of acceleration. And in S13, a scalar quantity is calculated from the acceleration along each axis. The scalar quantity is the magnitude of acceleration obtained by that an acceleration along each axis is squared, summed over 3 axis, and the square root of the sum yields this magnitude. In S14, by the processing the scalar quantities with the digital filter 153, only component within a predetermined frequency band (for example, 0.1 Hz-5 Hz) is extracted, and thus a noise component is removed.

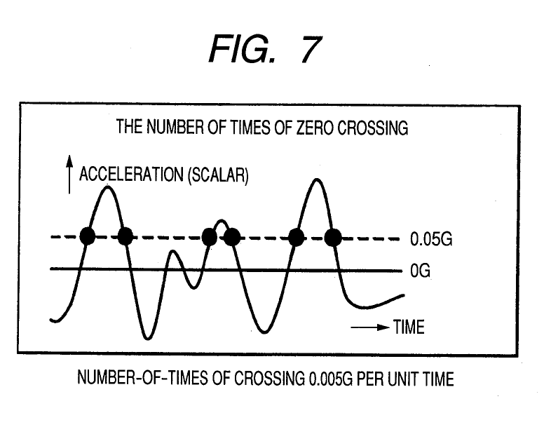

Next in S15, the number of times of the zero crossing is calculated from the scalar quantities of acceleration after filter processing. The number of times of the zero crossing counting calculates the number of times per unit time in which the magnitude of acceleration crosses the threshold around OG as shown in FIG. 7. According to the embodiment of the present invention, the number of times of the zero crossing per the cycle of the transmitting timer 152 (1 minute) the magnitude of acceleration crosses the threshold is counted as the number of times of the zero crossing and transmitted.

Here the number of times of the zero crossing counting can be prevented from an erroneous detection by setting a threshold to a little larger value, e.g. 0.05 G than 0 G.

That is, a human body has a possibility of causing an erroneous decision, if the threshold value is set to 0 G, the number of times of the zero crossing is generated to decide the person is moving even when the human body is in a quiescent state under sleep etc. by an influence of the exteriors, such as a very small body motion or vibration etc. For this reason, by making a threshold value a little larger than 0 G 0, e.g. 05 G, an erroneous decision can be prevented to decide the person is in a moving state due to a very small motion when the person is in a moving state a human body is in a quiescent state, and the detecting accuracy of behavior information can be improved.

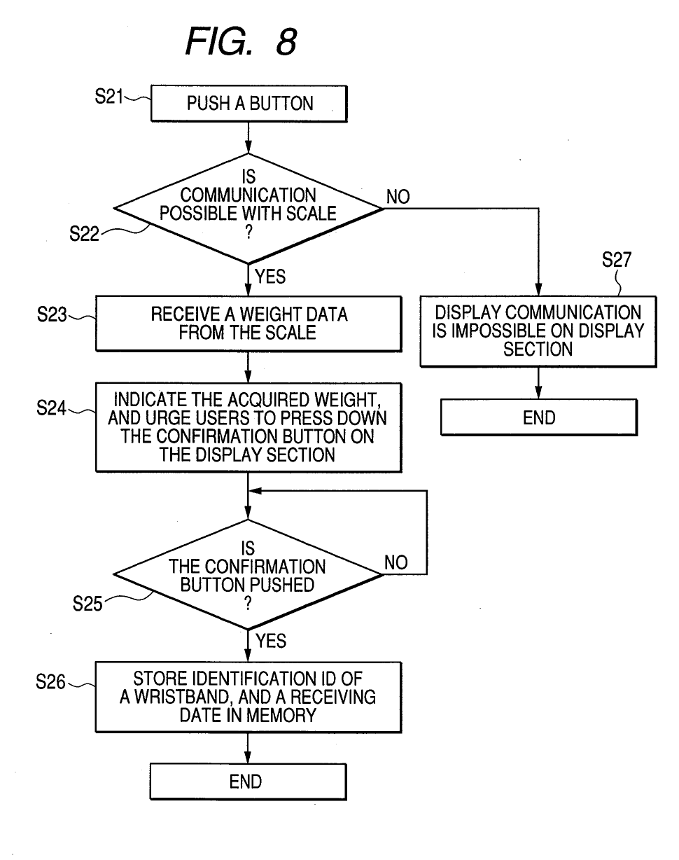

Next, FIG. 8 is a flow chart showing an example of a weight measuring process performed by the control section 15, when a wearing person pushes the button B103 of sensor node 1.

In S21, the control section 15 detects that the wearing person pushed the button B103 of the sensor node 1, and starts the processing to acquire a sensing data from the scale 2. In S22, whether the sensor node 1 can communicate with the scale 2 is decided.

In the processing, the communication section 16 measures the radio field intensity of the scale 2, and for example, it is decided that the communication is possible, if the radio field intensity is over a predetermined value. Or it my be decided that the communication is possible, if the communication section 16 of the sensor node 1 transmits a predetermined signal to the scale 2, and a predetermined response is obtained from the scale 2. Then, the wearing person of sensor nodes 1 rides on the scale 2, confirms that the weight measurement of the body is possible, and the processing proceeds to S23. If the communication is impossible, it is decided the measurement of weight can not be performed for the reason that the wearing person of the sensor node 1 is not near the scale 2, etc., and the processing proceeds to S27, where the control section 15 indicates on the display section 14 that communication is impossible with the scale 2, and then ends the processing.

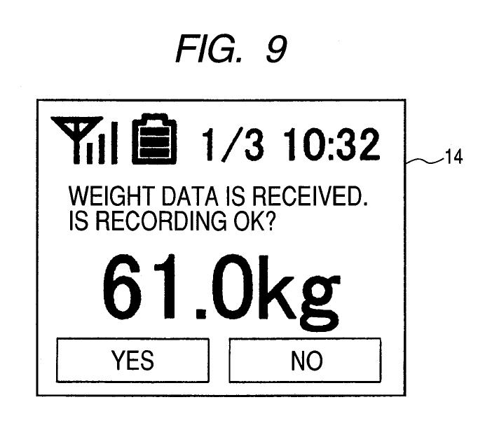

In S23, the sensing data of the wearing person's weight is received from the scale 2. The control section 15 let the display section 14 display the measured value of weight from the sensing data acquired in S24. The control section 15 outputs to the display section 14 an instruction to push the button B103 for the wearing person in order to make a confirmation of the completion of the body weight measurement. The display indicates the weight value received from the scale 2 on the display section 14, for example, as shown in FIG. 9. When recording the sensing data on the memory 17 (yes), the button B103 is made to be operated, and when not recording the sensing data (no), the button A102 is made to be operated.

In S25, if decision is made that the wearing person pushed the button B103, then the processing proceeds to S26. The identifier of the sensor nodes 1 (identifier to specify a wearing person), and the time when the sensing data is received from the scale 2 (time stamp) are added to the sensing data of the scale 2, and stored in the memory 17.

By the above processing, the sensing data of weight is transmitted to the sensor node 1 from the scale 2, and is stored in the memory 17 of the sensor node 1 by operating the button B103 after the wearing person of sensor nodes 1 rides on the scale 2. When it becomes a predetermined data transmission timing, the sensing data of the weight stored in the memory 17 is transmitted to the data server 6 with other sensing data via the base station 3 from the sensor node 1.

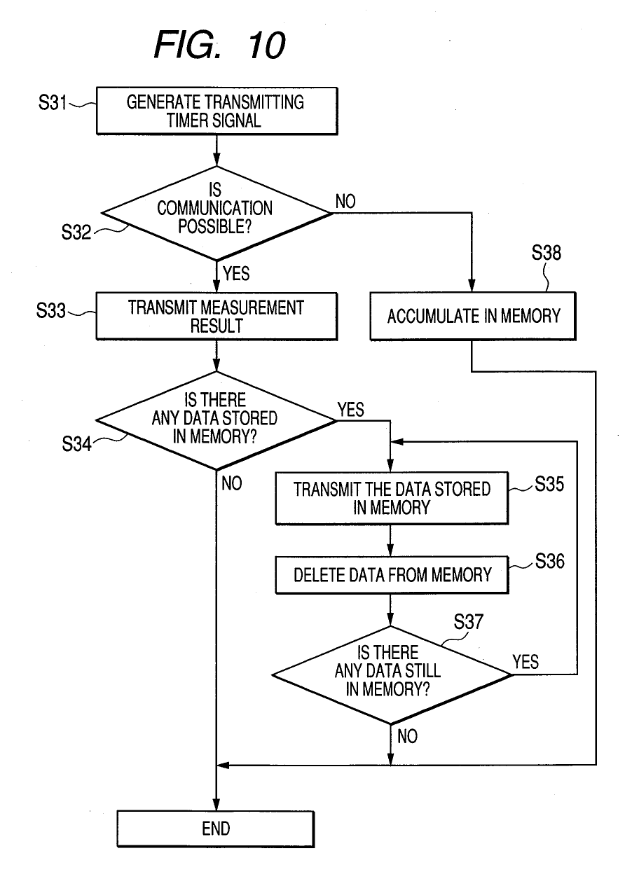

Next, FIG. 10 shows a flow chart in which an example of the transmission processing performed when an interruption is applied to the microcomputer of the control section 15 by the transmitting timer 152.

First in S31, receiving an interruption from the transmitting timer 152 the control section 15 activates the communication section 16. Next in S32, the control section 15 decides whether the communication section 16 can communicate with the base station 3. In the processing, for example, the communication section 16 measures the radio field intensity of the base station 3, and can decide the communication is possible if the radio field intensity is over a predetermined value. Or when the communication section 16 transmits a predetermined signal to the base station 3 and receives a predetermined response from the base station 3, then the control section 15 can also decide that the communication is possible.

In S33 after the decision, the sensing data recorded in the memory 17 is transmitted to the base station 3. In S34, the control section 15 decides whether an not transmitted sensing data exists in the memory 17, and if there is any not transmitted sensing data, in S35, the data read from the memory 17 is transmitted to the base station 3, and in S36, the transmitted sensing data is deleted from the memory 17. Furthermore, in S37, the control section 15 decides whether other not transmitted sensing data still remains in the memory 17, and if there is any not transmitted sensing data, the process returns to S35 and repeats the processing. On the other hand, if other not transmitted sensing data does not exist, the control section 15 ends the transmitting processing.

In the decision of S32, if the sensor node 1 cannot communicate with the base station 3, the processing proceeds to S38, stores the sensing data in the memory 17, and ends the processing.

By the above processing the sensing data stored in the memory 17 are transmitted collectively through wireless communication to the base station 3 at a predetermined cycle (for example, 1 minute) set to the transmitting timer 152. In the transmitting processing, in addition to the number of times of the zero crossing of the acceleration, a pulse rate, and temperature measured with corresponding sensors in the sensor node 1, the weight acquired from the scale 2 is also included in the sensing data, which is transmitted to the base station 3.

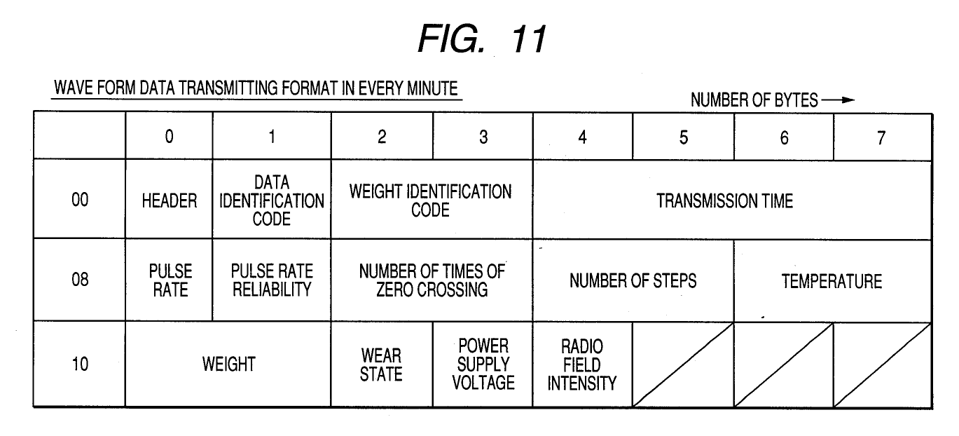

FIG. 11 shows an example of a transmission frame format of the sensing data transmitted by the sensor nodes 1 at a predetermined cycle (for example, 1 minute) of the transmitting timer 152.

The sensor node 1 adds the identifier (individual identification code) and transmission date set up beforehand to the sensing data (a pulse rate, the number of times of the zero crossing, temperature, and weight) stored in the memory 17, and then transmit the data. In FIG. 11, as for 08 (hexadecimal) bytes pulse rate the newest one in the sensing data shall be transmitted every 50 msec. And the pulse rate reliability of 09 bytes is a value based on the acceleration or a value associated with the acceleration when a pulse rate was measured, and larger the acceleration the reliability of the measured pulse rate becomes lower. The number of walks of 0C and 0D byte is the number of steps of a wearing person the control section 15 obtained based on the magnitude of acceleration. For the calculation of the number of steps, the peak of acceleration magnitude is extracted in a similar way as for the pulse rate counting, and the number of the peaks gives the number of steps. As for the weight of 10 or 11 bytes the sensing data is stored only when the weight from the scale 2 is received. The supply voltage of 14 bytes shows the voltage of a battery to drive the sensor nodes 1 (not illustrated).

### <Database>

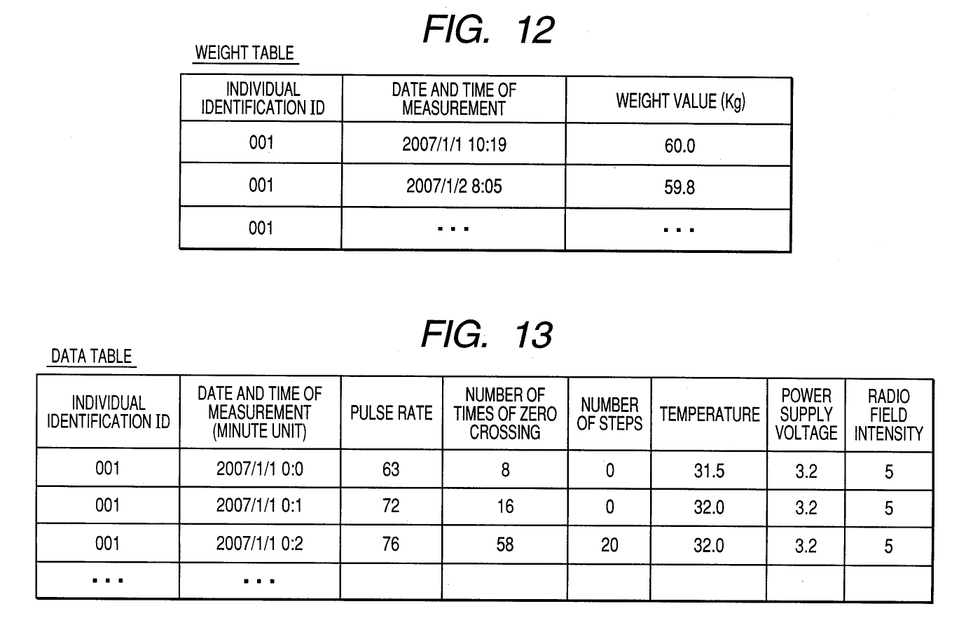

Next, referring to FIG. 12 and FIG. 13, the sensing data stored in the database 61 of the data server 6 is explained. FIG. 12 shows an example of the contents of weight table 62 which stores the weight measured with the scale 2, and FIG. 13 shows an example of the contents of data table 64 which stores the pulse rate, the number of times of the zero crossing, the temperature, and the number of steps measured by the sensor node 1.

In FIG. 12, the weight data measured with the scale 2, the identifier (individual identification ID in the figure) of the sensor node 1 and the measured time are added thereto, and stored in the weight table 62 as the sensing data. The identifier (individual identification ID) of the sensor node 1, and the time of a measurement date and a weight value are stored in each record of the weight table 62.

The analyzer apparatus 7 is for every individual identification ID serially referred to the weight table 62 as will be mentioned later.

In FIG. 13, the individual identification ID comes at the head, then the measurement date and time of the sensing data, a pulse rate, the number of times of the zero crossing, the number of steps, the temperature, the supply voltage, and the radio field intensity measured with the sensor node 1, and stored in the data table 64. The analyzer apparatus 7 is for every individual identification ID serially referred to the data table 64 as will be mentioned later.

### <Scale>

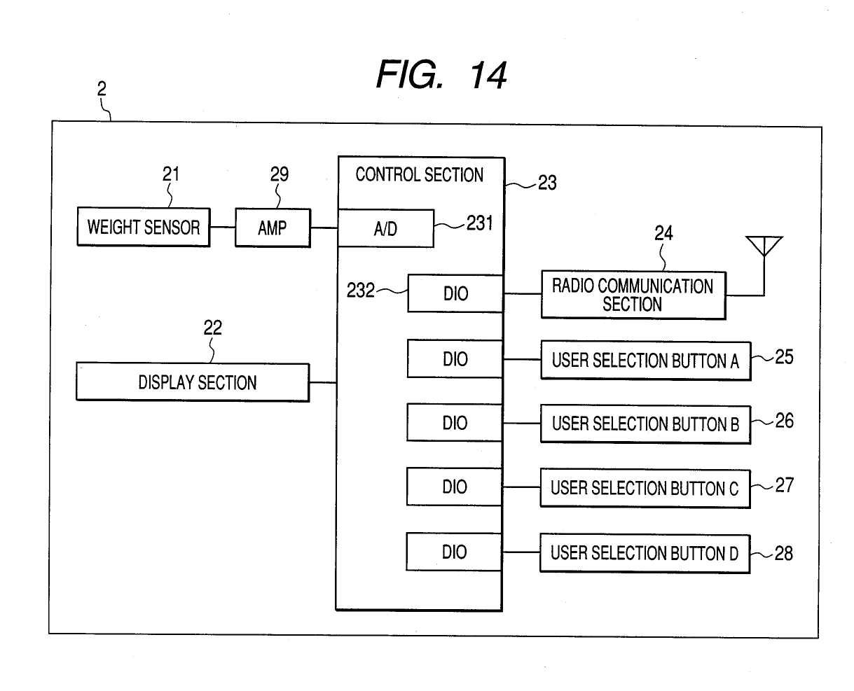

FIG. 14 is a block diagram showing the detailed composition of the scale 2. The scale 2 includes the weight sensor 21 for measuring the weight of a human body etc., display section 22 for displaying weight etc., the radio communication section 24 for communicating with the sensor node 1 or the base station 3, and the control section 23 containing a CPU and a memory for controlling user selection buttons A25-D28 beforehand assigned for every user who uses the scale 2.

The weight sensor 21 inputs a signal into an A/D converter 231 of the control section 23 via an amplifier 29. The signal amplified with an amplifier 29 is converted into a digital value by an A/D converter 231 of the control section 23, and the control section 23 calculates weight data from the converted digital value. The radio communication section 24 and the user selection buttons A25-D28 are connected to digital I/O 232 of the control section 23, respectively.

In order that the control section 23 may start up the weight sensor 21, may measure a user's weight and may transmit a sensing data to the sensor node 1 from the radio communication section 24, the control section 23 performs a predetermined measuring process. The measuring process of the control section 23 is started when a user (wearing person of the sensor node 1) operates either of the user selection buttons A25-D28.

If the user selection buttons A25-D28 are pushed, control section 23 directs the display section 22 to indicate that the user is urged to ride on the scale 2, after performing the calibration of the weight sensor 21.

When the user rides on the scale 2, the analog signal which is an output of the weight sensor 21 is amplified with the amplifier 29 and digitized with the A/D converter 231 of the control section.

After the measurement of weight is completed, the control section 23 displays the measured weight value on the display section 22, and transmits the weight data (sensing data) and the measurement date and time to the sensor nodes 1 via the radio communication section 24. After transmission of the sensing data is completed, the control section 23 converts to a standby state until an user selection button is pushed again. After the measurement of weight is completed, the control section 23 can store the measured value in user's information set up with the user selection buttons A25-D28.

### <Processing in the Whole System>

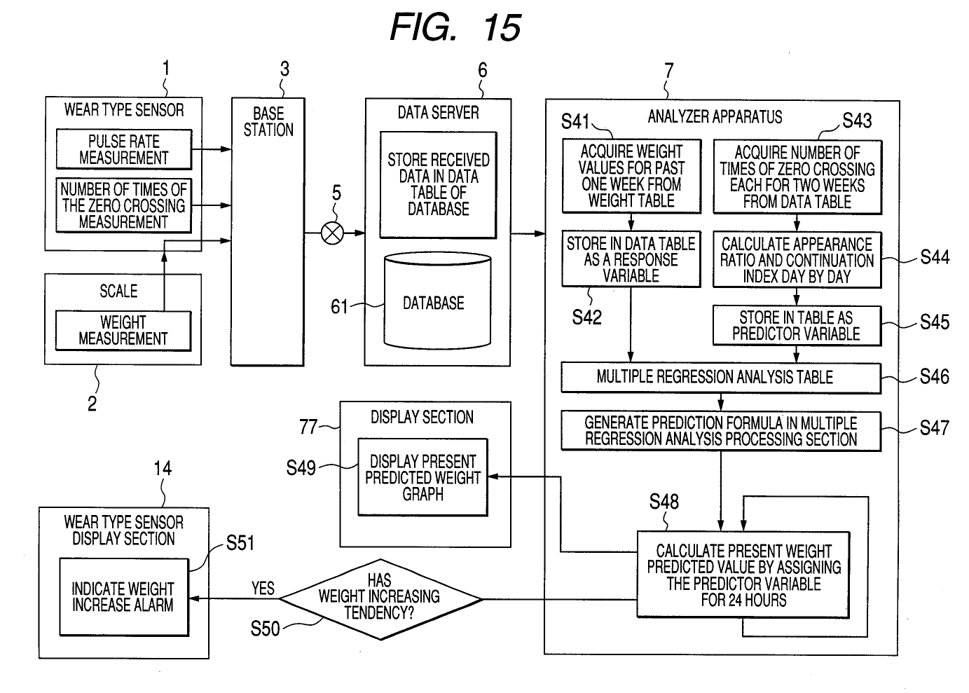

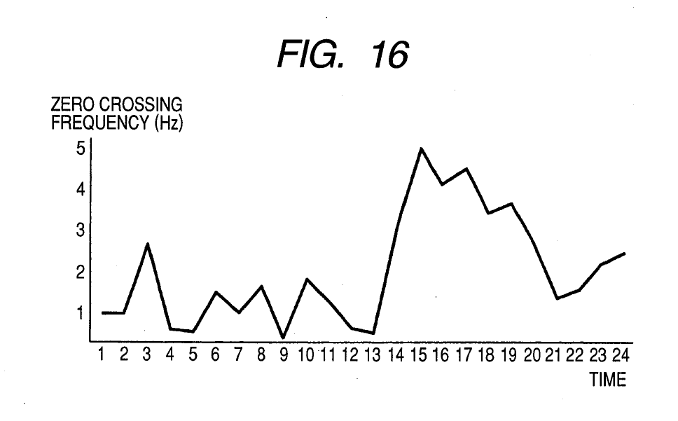

Next, the outline of data processing in the sensor net which predicts the present health index in real time is shown in FIG. 15 from the living body information (sensing data) measured in real time by the sensor node 1, and the health index (weight) measured discretely with the scale 2.

From the sensor node 1 worn to the human body the sensing data (the number of times of the zero crossing, pulse rate) measured in real time (such as every 50 ms), is transmitted to the base station 3 for every minute, and stored in the data table 64 of the data server 6 via the base station 3. New information on the living body is accumulated every minute in the data table 64.

The weight data discretely measured with the scale 2 is transmitted to the sensor nodes 1 when the measurement is made, and transmitted to the data server 6 together with the sensing data of the sensor node 1, then stored in the weight table 62. The eight data is discretely stored in the weight table 62.

In the analyzer apparatus 7, the living body information accumulated in real time and a health index (weight) accumulated discretely in the database 61 are supervised, and a predictive value of weight is computed, and if the predicted value of weight satisfies a predetermined condition such as increasing rapidly, then an analysis software is executed for transmitting warning to the sensor node 1 is by control section 71 of analyzer apparatus 7.

In an example of the processing which the control section 71 executes, the weight data within the prescribed past period (for example, one week) is first acquired from the weight table 62 of the data server 6 in FIG. 15 (S41). And the control section 71 stores the weight data within the prescribed period (the first prescribed period) acquired from the weight table 62 in the multiple regression analysis table 73 as a response variable (S42).

The control section 71 acquires the number of times of the zero crossing within the past second prescribed period (for example, two weeks) from the data table 64 of the data server 6 (S43). And the control section 71 converts the acquired number of times of the zero crossing into a zero cross frequency. Since the number of times of the zero crossing stored in the data table 64 shows the number of times of the zero crossing for the cycle (for 1 minute) of the transmitting timer 152 of the sensor nodes 1,

Zero crossing frequency=the number of times of the zero crossing/60 (sec).

Next, the control section 71 computes the appearance ratio (frequency of occurrence) and continuation index of the zero crossing frequency per each time day by day in S44.

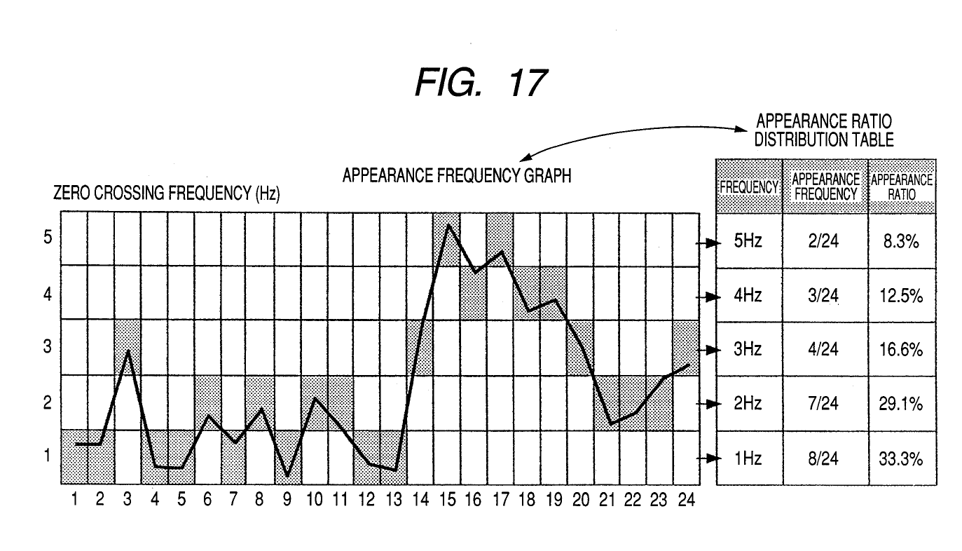

The appearance ratio of the zero crossing frequency is the average (or the maximum or standard deviation) of the zero crossing frequency for every time period in one day, as shown in FIG. 16. For example, in FIG. 16, time period =1 shows that the average of the zero crossing frequency for 0:01-1:00 o'clock is 1 Hz. After calculating the average of the zero crossing frequency for every time period, as shown in FIG. 17, the appearance ratio of the zero crossing frequency is calculated for every frequency band. In this example, a 1-5 Hz frequency band is divided into five partitions, and appearance frequency and an appearance ratio are calculated for every frequency band. In this example, 1 Hz or less is set to a frequency band (partition)=1 Hz, a frequency exceeding 1 Hz but no higher than of 2 Hz be 2 Hz, and similarly other frequency bands are classified.

The appearance ratio of a frequency band is obtained as the appearance frequency of each frequency band is divided by the total time band in a day.

For example, in the case that the frequency band=5 Hz, since the appearance is twice at time zone=15:00 and 17:00, the appearance frequency=2 and the appearance ratio is 8.3%. As for the appearance ratio, it can be judged that higher the frequency band (partition) is, stronger (more active) a wearing person's action is, and conversely lower the frequency band, weaker (more quiet) a wearing person's action.

Next, the control section 71 calculates the number of times the same frequency band adjoins each other in the time period, i.e. the number of times of continuation, then this number of times of continuation is divided by the appearance frequency is defined as a continuation index. Namely,

Continuation index=Number of times of continuation/Appearance frequency.

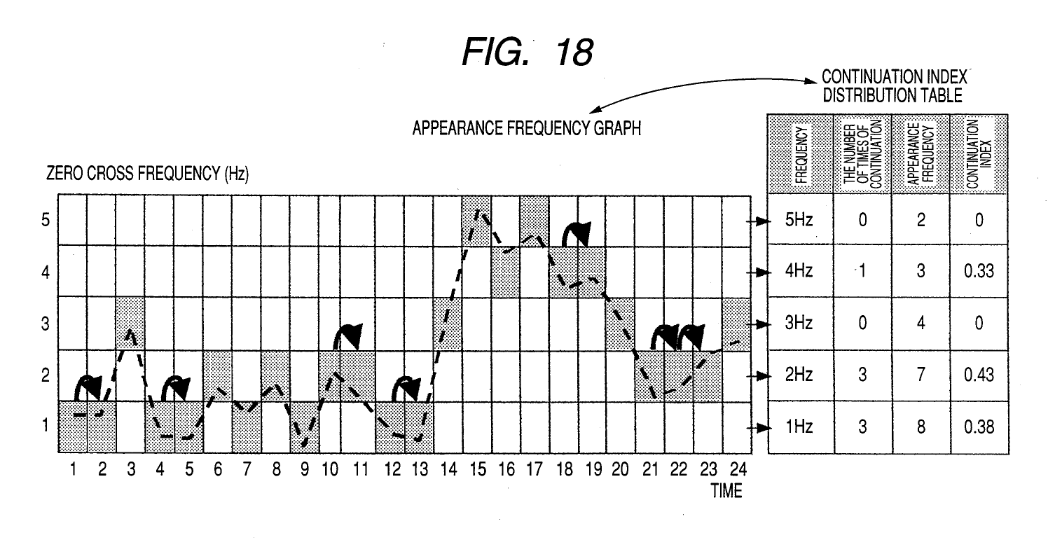

The number of times of continuation means the number of the time period for which the partition of zero crossing frequency is equal to one another. As shown in FIG. 18, the number of times of continuation is counted such that the frequency band of an adjacent time period is examined first and if the two frequency bands are the same, the number of times of continuation is set to 1. By performing this procedure with time period=1-24 for every frequency band, the number of times of continuation is obtained for one day, and the continuation index is obtained for every frequency band. For example, in FIG. 18, since the frequency band appeared is equal to 1 Hz at time period=1:00 and 2:00, the number of times of continuation is equal to 1. Similarly, since the time period with the frequency band=1 Hz continues at 4:00 and 5:00, 12:00 and 13:00, the number of times of continuation of the day is 3. And the appearance frequency of the frequency band=1 Hz is 8 times for the day, the frequency band=1 Hz continuation index is equal to 0.38. A continuation index shows degree of change with a wearing person's action, and if the continuation index is high in a low frequency band, it can be presumed that the wearing person is in a long quiet state, and if the continuation index is high in a high frequency band, it can be presumed that the wearing person is in a long active state.

Although the frequency band is assumed to be 1 Hz in the above, the band is not limited to 1 Hz, and the arithmetic precision of the number of times of continuation or the continuation index can be improved by dividing a frequency band more finely , e.g. by 0.1 Hz. Also as for the time period in the above example the time for a day is divided into 24 time periods, the time period is not limited to this period, and the arithmetic precision of the number of times of continuation or the continuation index can be raised by dividing the time period of one day. e.g. from 1 to 1440 period as the unit time period is one minute.

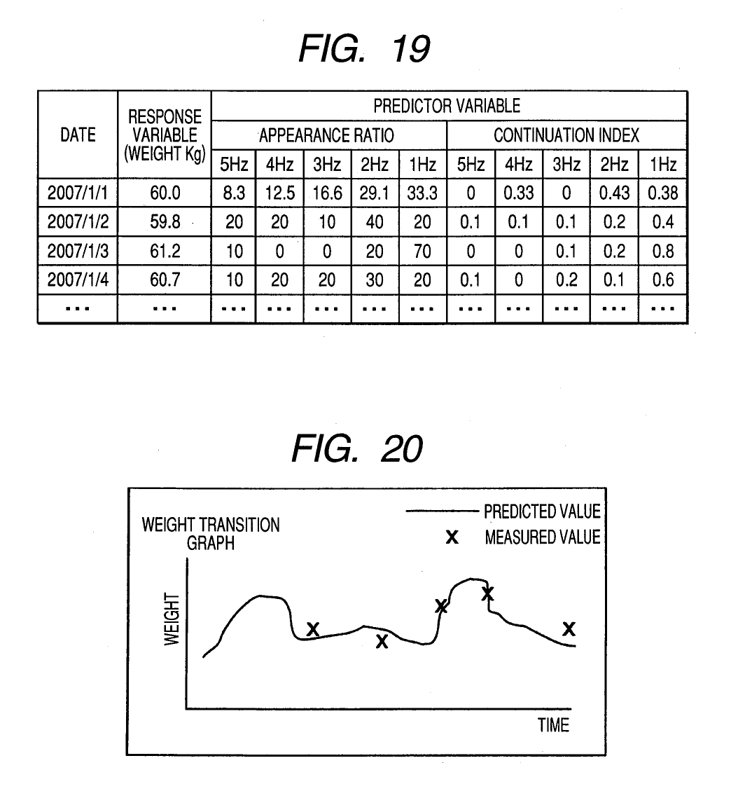

Next in S45 in FIG. 15, the appearance ratio and continuation index obtained in S44 are stored in the multiple regression analysis table 73 as predictor variables (S45). Thus, when the processing of S42 and S45 is finished, the preparation of analysis completes for the multiple regression analysis table 73 (S46). At this time, the information on a wearing person's body and behavior is stored in the multiple regression analysis table 73 of the analyzer apparatus 7, for example, as shown in FIG. 19. That is, weight data is specified as a response variable by using the date as a key, and the appearance ratio and continuation index for every frequency band are stored as a predictor variable in each record of the table.

Here, the weight data specified as a response variable is the weight data measured before going to bed on the day or in the morning of the following day, and reflected from the result of the action caught by the zero cross frequency based on acceleration (actual measurement is desirable in the morning of the following day).

Next, in S47 of FIG. 15, a prediction formula is generate by the multiple regression analysis processing section 74 of the control section 71 based on the response variable and the predictive variable set in the multiple regression analysis table 73.

Y=a₁x₁+a₂x₂+ . . . +aₙxₙ+a₀ Equation 1

Where,
y: response variable,
x₁-xₙ: predictor variables,
n: number of predictor variables,
a₁-aₙ: Coefficients, and
a₀: Constant term.

The prediction formula in S47 is generated using not all predictor variables, but meaningful predictor variables extracted with known technique such as a stepwise technique etc., and a process to remove variables which have multicollinearity in predictive variables etc. Here, since the multiple regression analysis processing is a well known technique, the explanation thereof is abbreviated. Extraction of these predictor variables is performed by the predictor variable generation section 75 in FIG. 1. By generating the above-mentioned predictor variable at the time of the updating of a response variable (weight data), or updating of an predictor variable (acceleration), a prediction formula is also updated as a new prediction formula reflecting the change of living body information, the updated prediction formula is able to make a prediction based on the most recent information (the second prescribed period). That is, since the number of times of the zero crossing is obtained from the second past prescribed period, the prediction formula can also change according to the change of living body information.

Next in S48 of FIG. 15, the multiple regression analysis processing section 74 substitutes the predictor variable within the past prescribed period (for example, 24 hours) for the above prediction formula thus generated, and computes the present predicted weight value, the response variable y by the multiple regression analysis.

And in S48 in FIG. 15, the value of response variable y obtained by the multiple regression analysis processing section 74, i.e., the predicted weight at present time, the past multiple regression analysis results, and the past measurement data of weight are indicated on the display section 77 of the analyzer apparatus 7. The display can be shown as a graph representing the predicted weight and measured weight values as a function of time, for example, as shown in FIG. 20. In FIG. 20, although the actual measurement of weight cannot always be made, and the resulting values distribute discretely, the predicted weight by the prediction formula can be generated continuously, and the variation of the health index of the person wearing the sensor node 1 can be indicated with the daily behavior of the person, without actual measurement.

The result of calculation of the response variable y may be stored in the storage device etc. of the analyzer apparatus 7 (not illustrate), or may be stored in the database 61. The predicted value of the response variable y may be calculated not only at the present time, but at the time of next measurement of the response variable.

Thus, by performing the processing the steps of S41-S49 of FIG. 15, whenever the sensing data is stored in the database 61, the weight data, i.e. a response variable is stored in the database 61, or at a predetermined cycle or whenever. It becomes possible to predict the body information (weight) unable to be measured always based on the behavior information of a wearing person in real time.

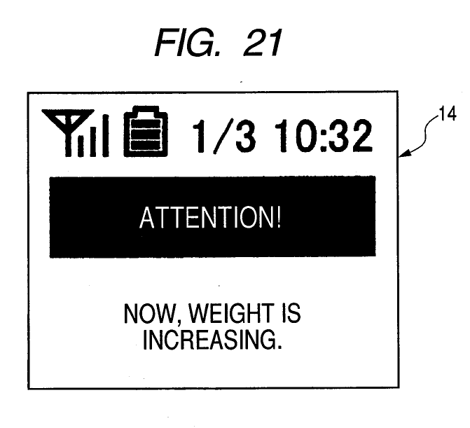

Furthermore, the multiple regression analysis processing section 74 obtains the changing rate of the predicted value of weight, whenever calculation of the predicted value is made, and if the changing rate of the predicted value of weight exceeds a predetermined value, a warning can be transmitted to the sensor node 1 as shown in FIG. 21. Or also when the rate of change of the predicted value of weight is less than the second predetermined value, a warning can be transmitted that the loss in weight does not become excessive.

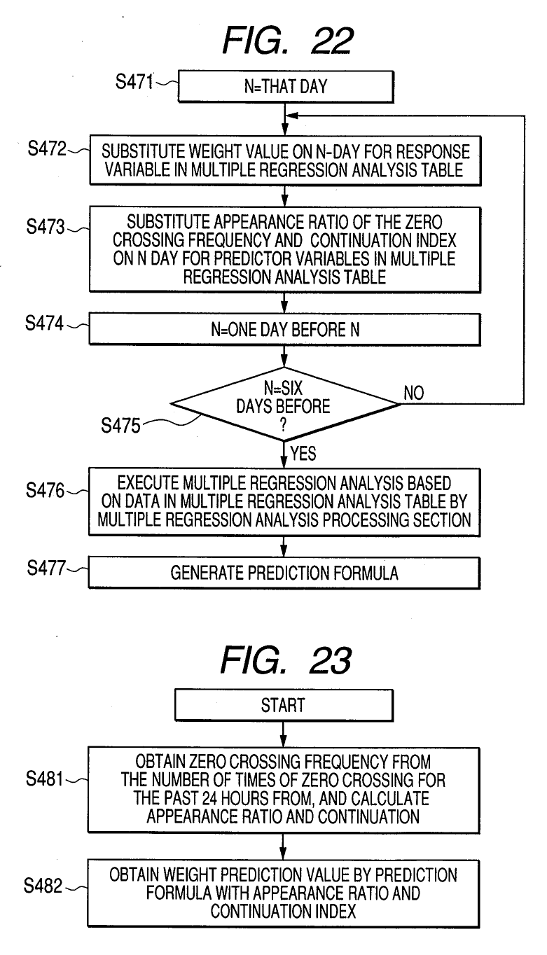

FIG. 22 is a flow chart showing an example of the generation of a predictor variable performed in the predictor variable generating section 75 and the multiple regression analysis processing section 74 and the generation processing of a prediction formula. In the following example a case is shown in which a multiple regression analysis is performed using the weight data and the predictor variable (number of times of the zero crossing) for the last one week. The steps from S471 to S475 is equivalent to the predictor variable generating section 75, and the steps S476-S47 deserve the multiple regression analysis processing section 74.

First in S471, the predictor variable generating section 75 sets up the date to perform the multiple regression analysis processing for a variable N (in the following, N day). Here, the present date is set up. Next in S472, the weight data on N day is assigned to a response variable in the multiple regression analysis table 73.

Next in S473, the number of times of the zero crossing on N day is acquired from the data table 64 of the database 61, and converted into the zero crossing frequency similarly in S44, an appearance ratio and a continuation index are obtained, and the appearance ratio and the continuation index are assigned to the predictor variables in the multiple regression analysis table 73.

Next in S474, N day is set to the previous day, and in S475, it is decided whether N day reached six days ago. If not reached yet, the processing returns to S472, assignment of a response variable and an explaining variable is repeated. If 7-day values (appearance rate of zero crossing frequency and continuous index) is assigned in multiple regression analysis table 73, the processing proceeds to S476.

In S476, the multiple regression analysis processing section 74 performs a multiple regression analysis based on each variable set in the multiple regression analysis table 73. And a prediction formula is generated based on the result of the multiple regression analysis (S47).

Although the above mentioned example shows an example in which a prediction formula is generated whenever a new response variable (weight data) is registered in the data server 6 assuming the weight is measured once per day, a prediction formula may be generated whenever a new sensing data (the number of times of the zero crossing, pulse rate) is registered in the database 61. And although the above mentioned example shows an example in which a prediction formula is generated based on the sensing data for seven days, especially if the weight data which serves as a response variable is one week, it is desirable to prepare the data (number of times of the zero crossing) for two weeks based on the sensing data used as an predictor variable.

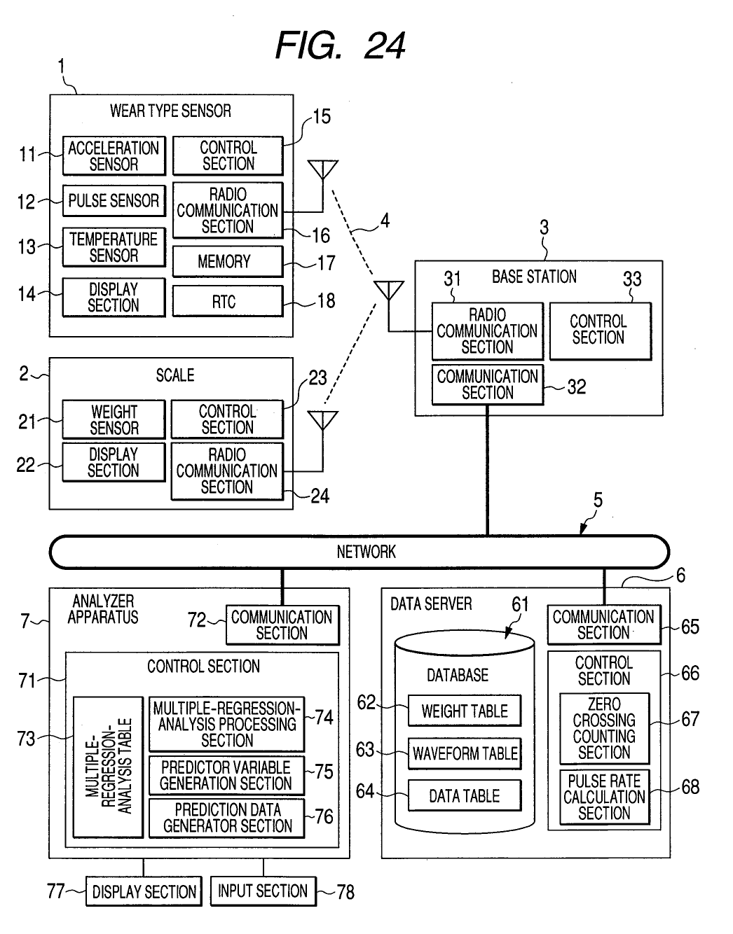

FIG. 23 is a flow chart showing an example of the processing performed by the prediction data generating section 76 of the analyzer apparatus 7 of FIG. 1, and the processing is equivalent to the processing of S48 in FIG. 15. First in S481, the prediction data generating section 76 acquires the number of times of the zero crossing within the past prescribed period (for example, 24 hours) from the sensing data stored in the data table 64 of the data server 6, obtains the zero crossing frequency as mentioned above, and calculates the appearance ratio and the continuation index.

And the predicted value of weight is computed by substituting the appearance ratio and the continuation index into the prediction formula obtained by the processing in FIG. 22.

As described above, the present inventor found that as for the health index which cannot always be measured, if recording the data on body information and behavior information which are acquired from an acceleration sensor, then a prediction formula can be formulated with a high correlation for any arbitrary health index, such as a weight, based on these data.

This is because the information on the body and the behavior of a user (wearing person) recorded always is a record reflecting comprehensively the body condition and the state of action, and the weight is a result thereof. For example, if the zero crossing frequency, as behavior information, is frequently at high frequencies, the wearing person is working actively, and if the zero crossing frequency is frequently at low frequencies, the wearing person is in a quiet state. That is, if a person behaves active, the energy consumption is large, consequently it can be predicted that the person reduce the weight, and if a person behaves passive, the energy consumption is small, consequently it can be predicted that the person maintains or increases the weight.

Namely, let the weight, unable to be measured always, be a response variable and a reference value set up discretely, and the results of measurement always made on a user's body condition (pulse) and action (acceleration) be predictor variables and recorded. By the statistical analysis using mainly a multiple regression analysis, a prediction formula is automatically generated from the correlativity of a response variable and a predictor variable, degree of achievement of the following day for a target can be predicted from a user's daily behavior, and the action contributing to goal achievement remarkably, or the action obstructing can be detected in real time, and an alarm can be submitted. It becomes possible to observe transition of a health index by keeping continuously the weight which cannot always be measured.

Thereby, it can know in real time that change of the situation which a user only always records physical conditions and an action situation by sensor nodes 1, and the prediction of the trend over arbitrary items to know of him is attained, and contributes to the target achievement greatly broke out.

Therefore, it becomes possible that by feed back the health index predicted to the user (wearing person), a user recognizes in everyday life what kind of influence daily unconcerned action may have upon the variable (weight), being a purpose, and to excite attention that suitable living activities can be done.

The parameter (health index) which cannot always be measured or a parameter with low measurement frequency (or parameter which can be measured only discretely) is obtained by the multiple regression analysis (prediction) with interpolation (prediction) from the always measurable variables (acceleration, pulse rate), and the values obtained by interpolation (prediction) can be fed back to the display section 17 of the sensor node 1, or the display section 77 of the analyzer apparatus 7 as the value of parameter. The value of the parameter (health index) which cannot always be measured can be predicted by the multiple regression analysis.

Whenever a health index is updated, or whenever the always observed living body information is updated, a prediction formula is updated, and a variation of living body information as an predictor variable may be learned.

In the present first embodiment, since the scale 2 is good enough to be able to transmit the measured weight to the sensor nodes 1, and not necessarily communicate directly with the base station 3, provided that communication between the sensor node 1 and the base station 3 is possible. That is, the transmission output power of the scale 2 can be made small, allowing extending the life of the power supply of the scale 2.

Although in the first embodiment an example is shown that the sensor node 1 measures the living body information including acceleration etc. every 50 msec, a variation in the living body information of the wearing person of the sensor node 1 is monitored almost continuously. The timing of the sensor node 1 to measure living body information with the acceleration sensor 11 or the pulse sensor 12 is satisfactory if the monitoring of the variation in the wearing person is made almost continuously with an interval of the timing, for example, a time interval between measurements, such as 100 msec or 1 sec, etc. may be sufficient.

Although the weight of a wearing person is preferably measured every day with the sensor node 1, the measurement cycle (timing) of weight by the wearing person is usually discrete and random, so that on the day the weight is unable to be measured the weight may be estimated from the weight data of before and after in the analyzer apparatus 7.

As for the relation of the first time interval between measurements of living body information by the sensor node 1, and the second time interval between measurements of weight with the scale 2, it is preferable to set the second time interval at least 100 times as long as the first time interval.

Although the measurement interval of each sensor of the sensor node 1 is set to 50 msec in an example of the first embodiment, however, it is not necessary to make all the measurement with the same cycle, and may be appropriately modified depending on the kind of the sensor. For example, the measurement cycle of each sensor may be different according to the kind of information to be acquired from a sensor, such as measurement with the acceleration sensor 11 is every 50 msec, measurement with the pulse sensor 12 every 5 minutes,.and measurement with the temperature sensor 13 every 10 minutes.

Although in the first embodiment an example is shown that as behavior information the acceleration of a person is measured by the sensor node 1 worn to the human body, however, the measurement is not limited to the above means, and a portable device having an acceleration sensor and a temperature sensor may be used, such as a cellular phone and a portable music player.

In the first embodiment the real time clock 18 is desirably set in the exterior of the microcomputer constituting the control section 15 of the sensor node 1. By setting up the real time clock 18 to the exterior of a microcomputer, in the period a measurement is not carrying out the microcomputer may be shifted to a sleeping mode, promoting the reduction of power consumption.

In the first embodiment the prediction formula can be executed repeatedly at a predetermined timing, such as whenever a weight data as a response variable or a sensing data as a predictor variable is updated. It is also possible to generate a prediction formula at a predetermined cycle.

### Second Embodiment

FIG. 24 is a block diagram to show a second embodiment of the information management system in which the number of times of the zero crossing counting section 154 and the pulse rate calculation section 155 are moved to the data server 6, and the arithmetic load of the sensor nodes 1 is reduced.

And the power consumption of the sensor node 1 is suppressed at the time of transmitting data, since the scale 2 transmits the measured weight data directly to the base station 3.

The number of times of the zero crossing calculation section 154 and the pulse rate calculation section 155 shown in FIG. 1 of the first embodiment are deleted from the sensor node 1, the measured values of the sensors are each converted into digital values by the A/D converters 156 and 157, transmitted to the base station 3, and stored in a waveform table 63 provided in the database 61 of the data server 6.

The composition of the data server in the second embodiment is different from that of the first embodiment in that a waveform table 63 is newly provided in the database 61, and a zero crossing calculation section 67 and a pulse rate calculation section 68 are mounted on the control section 66. Other composition is the same as that of the first embodiment.

In FIG. 4, the output of the X-axis sensor, the Y-axis sensor, and the Z-axis sensor of the acceleration sensor 11 measured at the measurement cycle (for example, 50 msec) of the measuring timer 151 and the output of the pulse sensor 12 are stored in the memory 17, and the output of the acceleration sensor 11 and the output of the pulse sensor 12 are collectively transmitted at the cycle of the transmitting timer 152 (for example, 1 sec). The output of the temperature sensor 13 at the time of collective transmission may be transmitted to the base station 3 as the temperature data.

When the scale 2 transmits the measured weight to the base station 3, a correlation is established between a wearing person of the sensor node 1 the weight measured therewith, and the weight data of the scale 2 by the control section 66 of the data server 6. A sensor node 1 in which the acceleration was low at the time of weight measurement may be selected to be the one which measured the weight, among the sensing data of the sensor node 1 received from base station 3 which communicates with the scale 2. Or in the case that a plurality of base stations 3 exist, the position of the sensor node 1 can be measured by plural base stations 3, and a sensor node 1 which existed in the position of the scale 2 can be specified, and then the measured weight data can be correlated to the identifier of the sensor nodes 1 concerned. The measuring times of weight data may be known from the time stamp of the base station 3 or the data server 6.

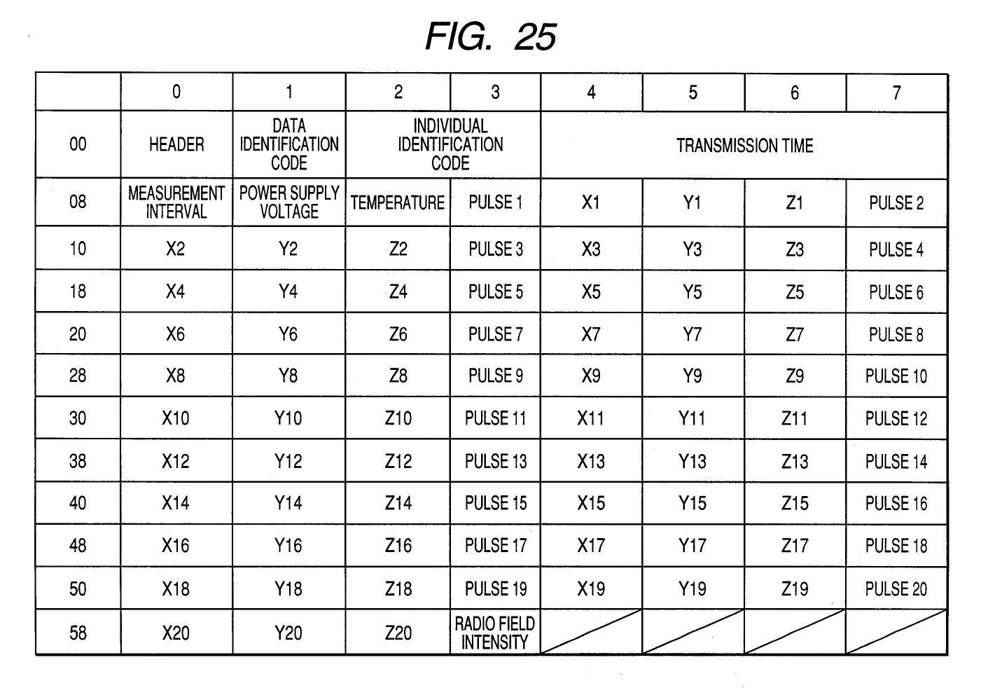

When a measurement cycle of the sensor nodes 1 is set to 50 msec and a transmission period is set to 1 sec as described above, 20 outputs of the acceleration sensor 11 along the X-axis, the Y-axis, and the Z-axis each, and the pulse sensor 12 are collectively transmitted by one transmission. An example of the frame format is shown in FIG. 25 for transmitting a sensing data to the base station 3 by the sensor node 1.

The sensor node 1 adds the identifier (individual identification code) and transmission date set up beforehand to the sensing data in FIG. 25, and transmits the output of the acceleration sensor 11 of X-axis, Y-axis, and Z-axis, and the pulse sensor 12 in the order of measured time as in the first embodiment. That is, the output X1 of the acceleration sensor 11 in FIG. 25 shows the oldest data of 1 sec ago, and the X20 shows the newest data. When the weight data is received from the scale 2, the weight is stored in 62 bytes after the radio field intensity in 61 bytes in FIG. 25.

Receiving the sensing data shown in FIG. 25 from the base station 3 the control section 66 of the data server 6 calculates the measuring times of 20 sensing data each for the output of acceleration sensor 11 (X1, Y1, Z1-X20, Y20, Z20), and the output of pulse sensor 12 (pulse 1-pulse 20), from the transmission time contained in the transmission frame and a known measurement cycle (50 msec).

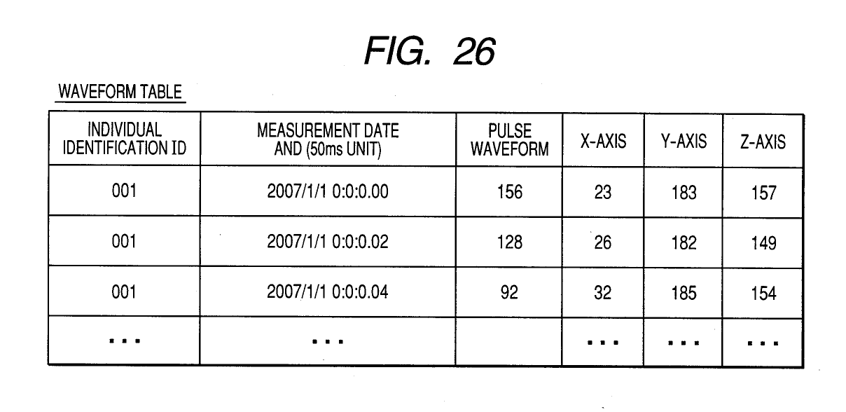

And the control section 66 of the data server 6 stores data records in which one record is made up from an identifier of sensor node 1, measured values of acceleration sensor 11 of the X-axis, the Y-axis, and the Z-axis, and a measured value of the pulse sensor 12, in the waveform table 63 of the database 61 for every measuring time as shown in FIG. 26. When a weight data is contained in the sensing data from the sensor node 1, the weight data is stored in the weight table 62 similarly as in the first embodiment.

The control section 66 stores the sensing data received from the base station 3 in the waveform table 63, the zero crossing calculation section 67 and the pulse rate calculation section 68 calculate the number of times of the zero crossing, a pulse rate, and the number of steps, etc. and the results are stored in the data table 64 similarly as in the first.

The analyzer apparatus 7 is the same as that of the first embodiment, generates a prediction formula based on the number of times of the zero crossing and the weight read from the database 61 of the data server 6, and obtains the predicted value of weight.

As described above, the sensor node 1 transmits the measured waveform (sensing data) without processing (number of zero crossing times, a pulse rate) in the second embodiment, and the number of times of the zero crossing and a pulse rate are calculated are in the data server 6, and stored as a sensing data in the database 61, so that the processing load the sensing data for the sensor node 1 is reduced and the power consumption is also reduced.

Since processing of the sensing data is performed by the data server 6, the arithmetic logic of counting the number of times of the zero crossing, or counting the pulse rate is more easily modified to be more useful for a prediction of the health index.

### Third Embodiment

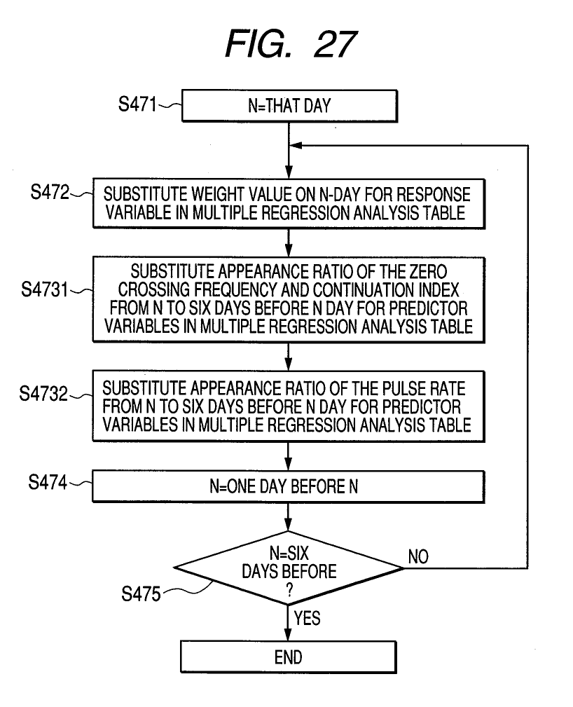

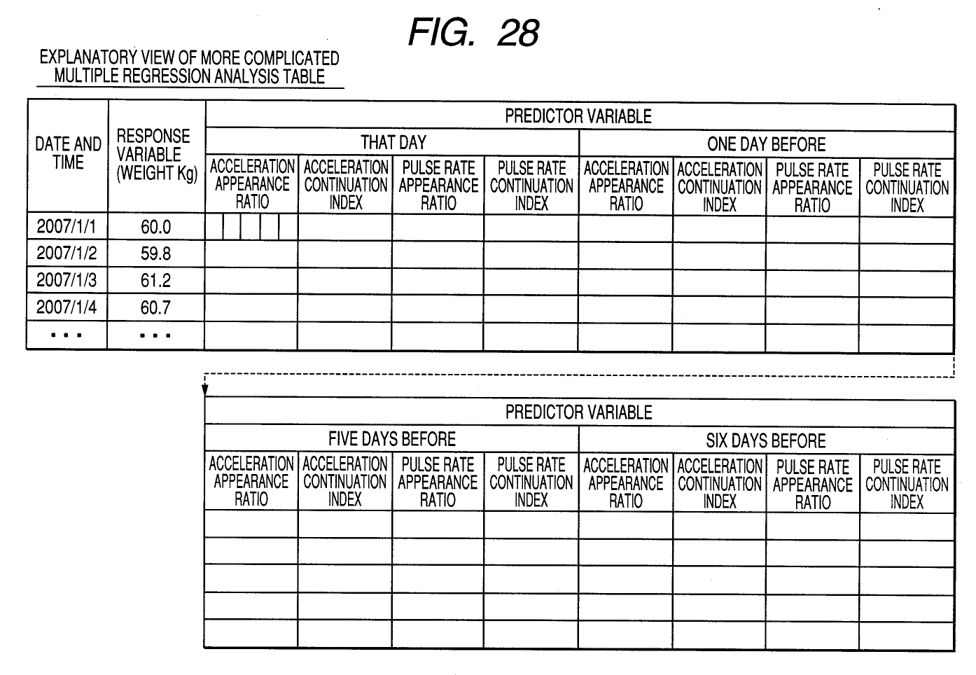

FIG. 27 and FIG. 28 show a third embodiment of the invention, in which a pulse rate is added to the number of times of the zero crossing as a predictor variable in the first embodiment.

FIG. 27 is a flow chart to show an example in which a part of processing is modified to generate a predictor variable performed by the predictor variable generation section 75 in the first embodiment. The following examples show that a multiple regression analysis table 73 for performing a multiple regression analysis is generated using the weight data and the predictor variable (the number of times of the zero crossing and pulse rate) for the past seven days in order to learn past weight data. In this case, a prediction is made with the response variable and the predictor variable for one week, and a sampling period of the number of times of the zero crossing, one of the predictor variables may be reduced compared with the first embodiment.

In FIG. 27, first in S471 the predictor variable generation section 75 sets up the date, a variable N (the following, N day) when the multiple regression analysis processing is to be performed. Here, the present date is set up. Next in S472, the weight data on N day is substituted for a response variable in the multiple regression analysis table 73. Here, if there were any deficit in the weight data, pseudo data could be generated based on a deficit data method of substitution etc., and stored as a response variable.

Next in S4731, the number of times of the zero crossing data for the days N-(N−6) is obtained from the data table 64 in the database 61. The number of times of the zero crossing is converted into the zero crossing frequency as shown in S44 of FIG. 15 in the first embodiment, and the appearance ratio and the continuation index are calculated, and then the appearance ratios and the continuation indexes thus obtained are substituted for the predictor variables in the multiple regression analysis table 73.

Next in S4732, the pulse rate for the days N-(N−6) is obtained from the data table 64 of the database 61. The appearance ratio and the continuation index of a pulse rate are calculated as shown in S44 of FIG. 15 in the first embodiment, and then the appearance ratios and the continuation indexes thus obtained are substituted for the predictor variables in the multiple regression analysis table 73. Here, the pulse rate stored in the data table 64 as sensing data are divided into 6 intervals; 50 or less, 50-69, 70-89, 90-109, 110-129, and 130 or larger interval, and the appearance ratio and the continuation index are computed in a similar manner as for the zero crossing frequency and substituted for the predictor variables in the multiple regression analysis table 73.

Next in S474 and in S475, similarly to in FIG. 22 of the first embodiment, one day is subtracted from N days to become the following day, a decision is made whether N days reaches six days ago, if not reached, the processing returns to S472 and substitution of a response variable and a predictor variable is repeated, and updating the multiple regression analysis table 73 with the substituted values (appearance ratio and continuation index of zero cross frequency and pulse rate) for seven days.

By the above processing, predictor variables for seven days (the appearance ratio and continuation index of zero crossing frequency and the pulse rate) are set up for one response variable (weight data) in the multiple regression analysis table 73 as shown in FIG. 28.

Then, the processing of S476 and S47 of FIG. 22 in the first embodiment are executed by the multiple regression analysis processing section 74 and the prediction formula is generated using the zero crossing frequency and the pulse rate as the predictor variables.

in this example, the zero crossing frequency for one week is selected as behavior information and the pulse rate for one week is also selected as body information, and used as a predictor variable in order to predict a health index (weight as an object variable). In addition to everyday behavior, it becomes possible to feed back about a state of tension by a pulse rate change or about variation of the health index by stress etc., to a wearing person.

In the third embodiment, the inventers of the present invention confirm that the weight, a response variable, can be predicted with high precision by the sensing data of the number of times of the zero crossing and the pulse rate as predictor variables for two days.

### Fourth Embodiment

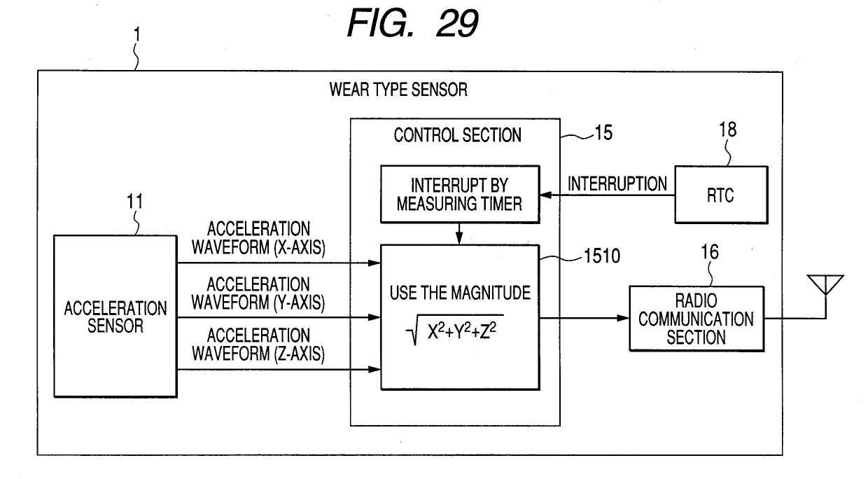

FIG. 29 shows a forth embodiment of the present invention, in which the output of acceleration sensor 11 is not transmitted directly to the base station 3 as is transmitted by the sensor node 1 in the second embodiment, but only the magnitude of acceleration, a scalar, is transmitted to the base station 3. The other composition is the same as that of the second embodiment.

The sensor node 1 includes a section 1510 to calculate the magnitude of acceleration along each axis of the X-axis, the Y-axis, and the Z-axis of acceleration sensor 11 in FIG. 29.

The sensing data of acceleration to be transmitted to the base station is a scalar obtained from the acceleration with three components calculated by the section 1510, the capacity of the frame is reduced resulting in the reduction of the transmitting load for the sensor node 1. The processing to calculate the magnitude of acceleration can be omitted with the data server 6 which stores the sensing data of the sensor node 1, and computation load can be reduced. Especially this becomes effective when the data server 6 stores and processes the sensing data of a large number of sensor nodes 1.

### Fifth Embodiment

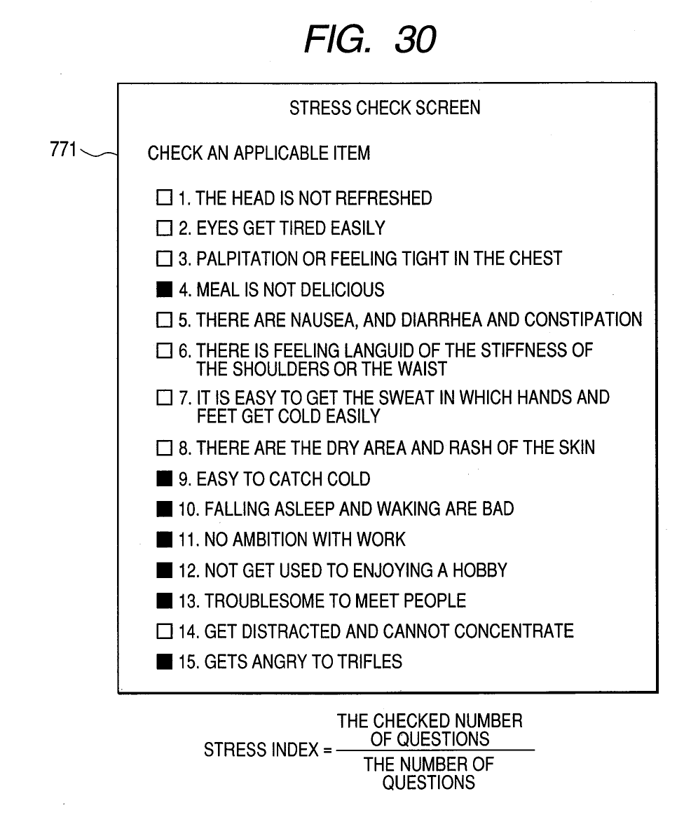

FIG. 30 shows a fifth embodiment of the present invention in which stress of the wearing person of the sensor node 1 is considered as a response variable instead of the weight in the first or the fourth embodiment.

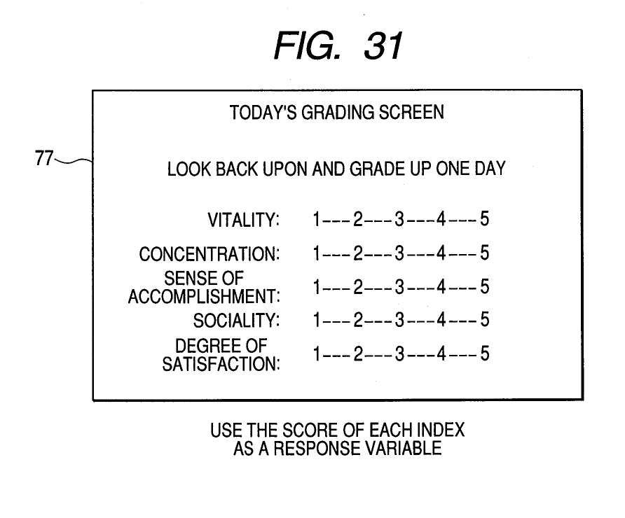

FIG. 30 and FIG. 31 show screens of the stress investigation outputted to the display section 77 of the analyzer apparatus 7. A user (a wearing person of sensor node 1) of the information management system is asked to reply to items of questions indicated on the display section 77 of the analyzer apparatus 7 periodically e.g. every day about user' body conditions and behavior. FIG. 30 shows questions about the user's health conditions, and the user is asked to tick off corresponding items of question via the input section 78. The analyzer apparatus 7 obtains a stress index defined as the stress index=ratio of the number of ticked items of question to the total number of items. This stress index is set up as a response variable from in the first to fourth embodiments, and a prediction formula is generated with measurable values by the sensor node 1 as predictor variables such as behavior information (acceleration) and body information (pulse), and a predicted value of the stress index is calculated.

Or each item of question is evaluated in five grades as shown in FIG. 31, and the user is asked to choose a suitable grade which serves as a kind of measured data.

Then, the value of grade of each item is set up as a response variable, and using the information on user's behavior (acceleration), and body (pulse) as predictor variables, a prediction formula is generated to give a predicted value on the stress index.

In this example, a stress which can not always measured is set to be a response variable, and user's body conditions and behavior which can be always measured are set to be predictor variables. Noticing the correlation between the variables of response and predictor, statistical analysis is applied to the two variables, i.e. a multiple regression analysis to generate a prediction formula. Using the formula, it is possible to predict an achievement in improving a health index of the following day, or to detect an item to contribute to an improvement appreciably or to impede improvement of a health index enabling to notify an alarm.

Furthermore, a value relating to health condition, such as body fat, a blood pressure (highest pressure, lowest pressure), the blood sugar level, fatigue, or other data of a periodical health examination result can be adapted as a response variable to show health indexes which can not be measured always. As for body fat, a blood pressure (highest pressure, lowest pressure), and a blood sugar level, the measured data may be inputted to the data server 6 similarly to the weight data measured periodically, and as for the fatigue or some health examination results, etc. may be inputted from the questions similarly to the stress index described above. Especially, when a health index is specified as a response variable, for example, blood sugar level etc. which can be measured only discretely, it will become possible to predict the health index in real time from always measurable everyday body information and behavior information continuously.

In addition, other indicators which can be set up as a response variable are productivity, safety management, etc., and for example, in a production site of software, a slowdown in productivity by an employee's stress, fatigue, can be predicted by setting up the value of bug occurrence frequency for a response variable.

Here, what is important is to be recognized by a user of the possible influence of user's behavior rather than an accuracy of a prediction made by using the information management system of the present invention, the influence on a response variable, a purpose, of unconcerned behavior in daily life is appreciated by feeding back a predicted value to a constant user.

As described above, the present invention can be applied to a life management system (health information management) for monitoring health indexes, such as weight and blood pressure, and especially, enables the prediction about a health index in real time by using a sensor net.

What is claimed is:

1. An information management system predicting a first parameter that is not always measured from a second parameter that is always measurable, comprising:
a first measurement section that measures the first parameter at a first timing;
a second measurement section that measures the second parameter at a second timing;
a data storing section which stores the values of the first measured parameter and the second measured parameter;
a prediction formula generator section which generates a prediction formula for calculating a predicted value of the first parameter at a third timing from the first parameters and the second parameters stored in the data storing section; and
a predicted value calculating section which calculates a predicted value of the first parameter based on the generated prediction formula and the second parameter,
wherein the prediction formula generator section generates the prediction formula at each predetermined timing.

2. The information management system according to claim 1,
wherein the prediction formula generation section, generates the prediction formula at the third timing when the first parameter is newly stored in the data storing section, or the second parameter newly stored in the data storing section; wherein the predicted value calculating section calculates the predicted value of the second parameter whenever the prediction formula is generated.

3. The information management system according to claim 1, further comprising:
an alarm generating section for generating warning when a predicted value of the second parameter becomes a predetermined threshold value.

4. The information management system according to claim 1,
wherein the prediction formula generator section, generates the prediction formula by learning a change of the second measurement parameter.

5. The information management system according to claim 1,
wherein the second measurement section is worn to a living body and measures a predetermined living body's information as the second parameter.

6. The information management system according to claim 5,
wherein the second measurement section, being constituted including an acceleration sensor and measures acceleration as the predetermined living body's information.

7. The information management system according to claim 1,
wherein the prediction formula generator section generates a prediction formula by a multiple regression analysis with the first parameter measured at the first timing as a response variable and the second parameter measured at the second timing as a predictor variable.

8. The information management system according to claim 5,
wherein the prediction formula generator section generates a prediction formula by a multiple regression analysis with the first parameter measured at the first timing as a response variable and the second parameter, an acceleration, measured at the second timing as a predictor variable.

9. The information management system according to claim 8,
wherein the prediction formula generation section comprises:
a scalar quantity calculation section that calculates a scalar quantity of the acceleration;
a zero crossing count calculation section that calculates the number of times the magnitude of acceleration crosses 0 or a predetermined value near zero, hereinafter referred to as the number of times of the zero crossing; and
a frequency calculating section that calculates the frequency of appearance of the number of times of the zero crossing within a prescribed period,
wherein the frequency of appearance is specified as an predictor variable.

10. The information management system according to claim 9,
wherein the prediction formula generation section further comprises:
a continuation index calculating section for calculating a continuation index defined as the number of continued time intervals divided by the total number of intervals with the same zero crossing frequency, and
wherein the frequency of appearance of the zero crossing within a prescribed period and the continuation index are specified as predictor variables.

11. An information management server comprising:
a communication section for receiving the first parameter that is not always measured and the second parameter always measured;
the data storing section storing the first parameter and the second parameter;
the prediction formula generator section for generating a prediction formula for calculating the predicted value of the first parameter from the first parameter and the second parameter stored in the data storing section in the information management server which calculates the predicted value of the first parameter from the measured first parameter and the measured second parameter; and
a predicted value calculating section for generating the prediction formula to calculate a predicted value of the first parameter based on the generated prediction formula and the second measured parameter, wherein the prediction formula generator section generates the prediction formula at every predetermined timing.

12. The information management server according to claim 11,
wherein the information management server generates the prediction formula when the first parameter is newly stored in the data storing section, or when the second parameter is newly stored in the data storing section, the predicted value calculating section calculates a predicted value of the second parameter whenever the prediction formula is generated.

13. The information management server according to claim 11, further comprising:
a warning generating section for generating a warning when a predicted second parameter satisfies predetermined conditions.

14. The information management server according to claim 11,
wherein the prediction formula generator section generates the prediction formula after learning the change of the second parameter.

15. The information management server according to claim 11,
wherein the prediction formula generator section generates a prediction formula by the multiple regression analysis with the first measured parameter as a response variable, and the second measured parameter as a predictor variable.

16. The information management server according to claim 11,
wherein the prediction formula generation section generates a prediction formula by the multiple regression analysis with the first parameter measured only discretely as a response variable, and the second parameter, acceleration, always measured as a predictor variable.

17. The information management server according to claim 16,
wherein the prediction formula generation section comprising:
a scalar quantity calculating section for calculating scalar quantity of the acceleration;
the number of times of a zero crossing calculation section for calculating number of times the magnitude of acceleration crosses 0 or a predetermined value near zero; and
a frequency calculating section for calculating the frequency of appearance of the number of times of the zero crossing within a prescribed period, wherein the frequency of appearance is specified as a predictor variable.

18. The information management server according to claim 17,
wherein the prediction formula generation section further comprising a continuation index calculating section for calculating a continuation index defined as the number of continued time intervals divided by the total number of intervals with same zero crossing frequency, and
wherein the frequency of appearance of the zero crossing within a prescribed period and the continuation index are specified as predictor variables.

19. The information management system according to claim 1,
wherein the first timing is discrete measurement interval, whereas the second timing is continuous enabling a continuous monitoring for a variation of living body.

20. The information management system according to claim 1,
wherein the second measurement section is constitute of a portable device.
